(19) United States
(12) Patent Application Publication
(10) Pub. No.: US 2014/0254468 A1
(43) Pub. Date: Sep. 11, 2014

(54) Downlink Control Signaling for a Backhaul Link

(71) Applicants: Bernhard Raaf, Neuried (DE); Gilles Charbit, Hampshire (GB); Xiangguang Che, Beijing (CN); Erlin Zeng, Beijing (CN); Lars Lindh, Helsinki (FI)

(72) Inventors: Bernhard Raaf, Neuried (DE); Gilles Charbit, Hampshire (GB); Xiangguang Che, Beijing (CN); Erlin Zeng, Beijing (CN); Lars Lindh, Helsinki (FI)

(21) Appl. No.: 13/520,816

(22) PCT Filed: Jan. 8, 2010
(86) PCT No.: PCT/CN2010/070089

§ 371 Date: May 1, 2014

(51) Int. Cl. H04W 16/26

(52) U.S. Cl. CPC H04W 16/26
USPC 370/315

(57) ABSTRACT

In one exemplary embodiment of the invention, a method includes: sending, within at least one of a first and a second symbol time, a first transmission having first downlink control information from a network access node to a first mobile node located within a first cell serviced by the network access node; and sending, within at least a third symbol time, a second transmission having second downlink control information from the network access node to a relay node over a wireless communication link that is a backhaul link, where the second transmission is configured to enable the relay node to send, within the first symbol time, a third transmission having third downlink control information from the relay node to a second mobile node located within a second cell serviced by the relay node, where the second cell is different from the first cell.

### TECHNICAL FIELD

The exemplary and non-limiting embodiments of this invention relate generally to wireless communication systems, methods, devices and computer programs and, more specifically, relate to downlink control signaling for a backhaul link.

### BACKGROUND

This section is intended to provide a background or context to the exemplary embodiments of the invention as recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
3GPP third generation partnership project
8PSK 8-state phase-shift keying
16QAM 16-state quadrature amplitude modulation
ACK acknowledgement
BH backhaul
BS base station
BW bandwidth
C-Plane control plane
CQI channel quality information
DeNB donor eNB
DL downlink (eNB towards UE)
DRX discontinuous reception
DTX discontinuous transmission
eNB E-UTRAN Node B (evolved Node B)
EPC evolved packet core
E-UTRAN evolved UTRAN (LTE)
FDMA frequency division multiple access
HSPA high speed packet access
IMT-A international mobile telephony-advanced
ISD inter-site distance
ITU international telecommunication union
ITU-R ITU radiocommunication sector
LTE long term evolution of UTRAN (E-UTRAN)
LTE-A LTE advanced (Rel-10 of E-UTRAN)
MAC medium access control (layer 2, L2)
MBSFN multicast/broadcast single frequency network
MM/MME mobility management/mobility management entity
NACK negative acknowledgement
Node B base station
OFDM orthogonal frequency division multiplexing
OFDMA orthogonal frequency division multiple access
O&M operations and maintenance
OS OFDM symbol
PCFICH physical control format indicator channel
PDCCH physical downlink control channel
PDCP packet data convergence protocol
PDSCH physical downlink shared channel
PHY physical (layer 1, L1)
PRACH packet random access channel or physical random access channel
QPSK quadrature phase-shift keying
RACH random access channel
RAN radio access network
RE resource element
REG resource element group
Rel release
Rel-8 LTE Release 8
Rel-10 LTE Release 10 (LTE-A)
RLC radio link control
RN relay node
R-PDCCH relay link (backhaul link) PDCCH
R-PDSCH relay link (backhaul link) PDSCH
RRC radio resource control
RRM radio resource management
RX reception/receive
SC-FDMA single carrier, frequency division multiple access
SF system frame
S-GW serving gateway
SR scheduling request
TA timing advance
TDD time division duplex
TTI transmission time interval
TX transmission/transmit
UE user equipment, such as a mobile station, mobile node or mobile terminal
UL uplink (UE towards eNB)
UTRAN universal terrestrial radio access network

The specification of a communication system known as evolved UTRAN (E-UTRAN, also referred to as UTRAN-LTE or as E-UTRA) is currently nearing completion within the 3GPP. As specified the DL access technique is OFDMA, and the UL access technique is SC-FDMA.

One specification of interest is 3GPP TS 36.300, V8.8.0 (2009-04), “3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8),” incorporated by reference herein in its entirety. This system may be referred to for convenience as LTE Rel-8 (which also contains 3G HSPA and its improvements). In general, the set of specifications given generally as 3GPP TS 36.xyz (e.g., 36.211, 36.311, 36.312, etc.) may be seen as describing the Release 8 LTE system. More recently, Release 9 versions of at least some of these specifications have been published including 3GPP TS 36.300, V9.1.0 (2009-9).

FIG. 1 reproduces FIG. 4.1 of 3GPP TS 36.300 V8.8.0, and shows the overall architecture of the E-UTRAN system 2 (Rel-8). The E-UTRAN system 2 includes eNBs 3, providing the E-UTRAN user plane (PDCP/RLC/MAC/PHY) and control plane (RRC) protocol terminations towards the UE (not shown). The eNBs 3 are interconnected with each other by means of an X2 interface. The eNBs 3 are also connected by means of an S1 interface to an EPC, more specifically to a MME by means of a S1 MME interface and to a S-GW by means of a S1 interface (MME/S-GW 4). The S1 interface supports a many-to-many relationship between MMEs/S-GWs and eNBs.

The eNB hosts the following functions:
functions for RRM: RRC, Radio Admission Control, Connection Mobility Control, Dynamic allocation of resources to UEs in both UL and DL (scheduling);
IP header compression and encryption of the user data stream;
selection of a MME at UE attachment;
routing of User Plane data towards the EPC (MME/S-GW);
scheduling and transmission of paging messages (originated from the MME);
scheduling and transmission of broadcast information (originated from the MME or O&M); and
a measurement and measurement reporting configuration for mobility and scheduling.

Of particular interest herein are the further releases of 3GPP LTE (e.g., LTE Rel-10) targeted towards future IMT-A systems, referred to herein for convenience simply as LTE-Advanced (LTE-A). Reference in this regard may be made to 3GPP TR 36.913, V8.0.1 (2009-03), 3rd Generation Partnership Project; Technical Specification Group Radio Access Network; Requirements for Further Advancements for E-UTRA (LTE-Advanced) (Release 8). A goal of LTE-A is to provide significantly enhanced services by means of higher data rates and lower latency with reduced cost. LTE-A is directed toward extending and optimizing the 3GPP LTE Rel-8 radio access technologies to provide higher data rates at very low cost. LTE-A will most likely be part of LTE Rel-10. LTE-A will be a more optimized radio system fulfilling the ITU-R requirements for IMT-A while maintaining backward compatibility with LTE Rel-8.

As is specified in 3GPP TR 36.913, LTE-A should operate in spectrum allocations of different sizes, including wider spectrum allocations than those of Rel-8 LTE (e.g., up to 100 MHz) to achieve the peak data rate of 100 Mbit/s for high mobility and 1 Gbit/s for low mobility. It has been agreed that carrier aggregation is to be considered for LTE-A in order to support bandwidths larger than 20 MHz. Carrier aggregation, where two or more component carriers (CCs) are aggregated, is considered for LTE-A in order to support transmission bandwidths larger than 20 MHz. The carrier aggregation could be contiguous or non-contiguous. This technique, as a bandwidth extension, can provide significant gains in terms of peak data rate and cell throughput as compared to non-aggregated operation as in LTE Rel-8.

A terminal may simultaneously receive one or multiple component carriers depending on its capabilities. A LTE-A terminal with reception capability beyond 20 MHz can simultaneously receive transmissions on multiple component carriers. A LTE Rel-8 terminal can receive transmissions on a single component carrier only, provided that the structure of the component carrier follows the Rel-8 specifications. Moreover, it is required that LTE-A should be backwards compatible with Rel-8 LTE in the sense that a Rel-8 LTE terminal should be operable in the LTE-A system, and that a LTE-A terminal should be operable in a Rel-8 LTE system.

FIG. 2 shows an example of the carrier aggregation, where M Rel-8 component carriers are combined together to form M×Rel-8 BW (e.g., 5×20 MHz=100 MHz given M=5). Rel-8 terminals receive/transmit on one component carrier, whereas LTE-A terminals may receive/transmit on multiple component carriers simultaneously to achieve higher (wider) bandwidths.

Since the new spectrum bands for IMT contain higher frequencies, and since LTE-A will provide higher data rates, the coverage of one eNB is limited due to the high propagation loss and limited energy per bit. Relaying has been proposed to enlarge the coverage, improve the capacity and improve the cell edge performance. General reference in this regard may be made to R1-082024 “A discussion on some technology components for LTE-Advanced”, Ericsson (2008); REV-080006 “Technical proposals and considerations for LTE advanced”, Panasonic; and to R1-081791 “Technical proposals and considerations for LTE advanced”, Panasonic (2008). To some extent, relaying also has potential for use in lower LTE spectrum bands.

However, as noted above backwards compatibility of LTE-A with LTE is required. That is, a UE compatible with LTE should be able to operate in a LTE-A network deployment. In its initial network development phase, building cost-effective coverage using the relaying approach may be an attractive proposition for network operators. For this reason, the design of a non-transparent relay concept with backwards compatibility with LTE Rel-8 UEs is desirable.

In R1-083752, “Wireless relaying for LTE evolution”, Ericsson, RAN1#54bis (2008), the concept of a donor cell for L3 relaying with self-backhauling was presented. Reference in this regard may be made to FIG. 3. The L3 relay node (referred to herein as a “L3 relay,” “relay”. or “RN”) may comprise an eNB supporting one or more cells of its own (e.g., one or more ‘sectors’). The L3 relay is accessible to Rel-8 UEs and provides its own DL common and shared control signaling (e.g., P-SCH, S-SCH, P-BCH and CRS) to allow the UEs to access the L3 relay cell, as would be the case for a traditional eNB cell. The main difference is that the L3 relay is wirelessly connected to the rest of the RAN via a “donor” cell, which would typically provide a larger coverage. This is commonly referred to as self-backhauling, where the S1 and X2 interfaces use wireless inband or outband resources.

As shown in FIG. 3, a RN 70 is in communication with a DeNB 80 within a wireless network 90 (e.g., a LTE-A system). The RN 70 provides coverage for a relay cell 72 while the DeNB 80 provides coverage for a donor cell 82. A UE2 74, such as a Rel-8 UE, for example, is configured to wirelessly communicate with the RN 70. Due to the communication between the RN 70 and the DeNB 80 (e.g., the S1 and X2 interfaces 76), the UE2 74 communicates with other devices 92 in the wireless network 90 via the RN 70 and the DeNB 80. Note that the DeNB 80 may have UEs of its own, such as a UE1 84, within its cell coverage (donor cell 82).

The L3 relay is typically placed outside the eNB donor cell coverage area for UEs with self-backhaul performed via inband or outband resources. The connection between the RN and the DeNB can be inband, in which case the network-to-relay link share the same band with direct network-to-UE links within the donor cell. Rel-8 UEs should be able to connect to the donor cell in this case. The connection could also be outband, in which case the network-to-relay link does not operate in the same band as direct network-to-UE links within the donor cell.

For inband resources, significant link gains due to, for example, antenna tilting, directional antennas and/or adequate positioning of the relay to minimize shadowing loss may be used. Reference in this regard may be made to 3GPP TS 36.211, v8.4.0, “E-UTRAN Physical Channel and Modulation”, September 2008. This provides flexibility for network operators but uses bandwidth for the self-backhauling depending on how many UEs are connected to the L3 relay and the traffic load.

For outband resources, a more powerful amplifier for the eNB-L3 relay link (76) may be used. This makes the backhaul link an add-on to a conventional eNB, and requires operators to have IMT-A spectrum and may complicate network deployments due to varying IMT-A spectrum allocations worldwide. This approach may increase the cost of the L3 relay and/or the donor cell.

With respect to the knowledge in the UE, relays can be classified as transparent, in which case the UE is not aware of whether or not it communicates with the network via the relay, or as non-transparent, in which case the UE is aware of whether or not it is communicating with the network via the relay.

Depending on the relaying strategy, a relay may be part of the donor cell, or control cells of its own. In the case the relay is part of the donor cell, the relay does not have a cell identity of its own (but may still have a relay ID). At least part of the RRM is controlled by the eNB to which the donor cell belongs, while parts of the RRM may be located in the relay. In this case, a relay should preferably also support LTE Rel-8 UEs. Smart repeaters, decode-and-forward relays and different types of L2 relays are non-limiting examples of this type of relaying.

In the case where the relay is in control of cells of its own (e.g., see FIG. 3), the relay controls one or several cells and a unique physical layer cell identity is provided in each of the cells controlled by the relay. The same RRM mechanisms are available, and from a UE perspective there is no difference in accessing cells controlled by a relay and cells controlled by a “normal” eNB. The cells controlled by the relay also should support LTE Rel-8 UEs. Self-backhauling (L3 relay) and “type 1 relay nodes” use this type of relaying.

3 GPP TR 36.814, V1.2.1 states that at least “Type 1” relay nodes are part of LTE-A. A “type 1” relay node is an inband relaying node characterized by the following: it controls cells, each of which appears to a UE as a separate cell distinct from the donor cell; the cells have their own Physical Cell ID (defined in LTE Rel-8); and the relay node transmits its own synchronization channels and reference symbols, etc. In addition, in the context of single cell operation the UE shall receive scheduling information and HARQ feedback directly from the relay node and send its control channels (e.g., SR/CQI/ACK/NACK) to the relay node. In addition, the relay node shall appear as a Rel-8 eNB to Rel-8 UEs (i.e., it is fully backwards compatible with Rel-8 UEs). Further, to LTE-A′ UEs it should be possible for a type 1 relay node to appear differently than a Rel-8 eNB to allow for further performance enhancements.

As was noted above, it is already assumed in 3GPP TR 36.814, V1.2.1 that a wireless DL backhaul (i.e., the link from the DeNB to the RN) will be implemented in a Rel-8 backwards compatible fashion. This is accomplished by configuring a MBSFN subframe in the RN cell. One difference between the backhaul link and a normal link (i.e., that between the DeNB and a macro cell UE, such as UE1 84) is that for the former the data traffic for multiple UEs under the RN cell is aggregated.

### SUMMARY

The below summary section is intended to be merely exemplary and non-limiting.

The foregoing and other problems are overcome, and other advantages are realized, by the use of the exemplary embodiments of this invention.

In one exemplary embodiment of the invention, a method comprising: sending, within at least one of a first symbol time and a second symbol time, a first transmission comprising first downlink control information from a network access node to a first mobile node located within a first cell that is serviced by the network access node; and sending, within at least a third symbol time, a second transmission comprising second downlink control information from the network access node to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

In another exemplary embodiment of the invention, a program storage device readable by a machine, tangibly embodying a program of instructions executable by the machine for performing operations, said operations comprising: sending, within at least one of a first symbol time and a second symbol time, a first transmission comprising first downlink control information to a first mobile node located within a first cell that is serviced by the machine; and sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

In a further exemplary embodiment of the invention, an apparatus comprising: first means for sending, within at least one of a first symbol time and a second symbol time, a first transmission comprising first downlink control information to a first mobile node located within a first cell that is serviced by the apparatus; and second means for sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

In another exemplary embodiment of the invention, an apparatus comprising: at least one processor; and at least one memory including computer program code, the at least one memory and the computer program code being configured to, with the at least one processor, cause the apparatus at least to perform: sending, within at least one of a first symbol time and a second symbol time, a first transmission comprising first downlink control information to a first mobile node located within a first cell that is serviced by the apparatus; and sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 reproduces FIG. 4 of 3GPP TS 36.300 V8.8.0, and shows the overall architecture of the E-UTRAN system.

FIG. 2 shows an example of carrier aggregation as proposed for the LTE-A system.

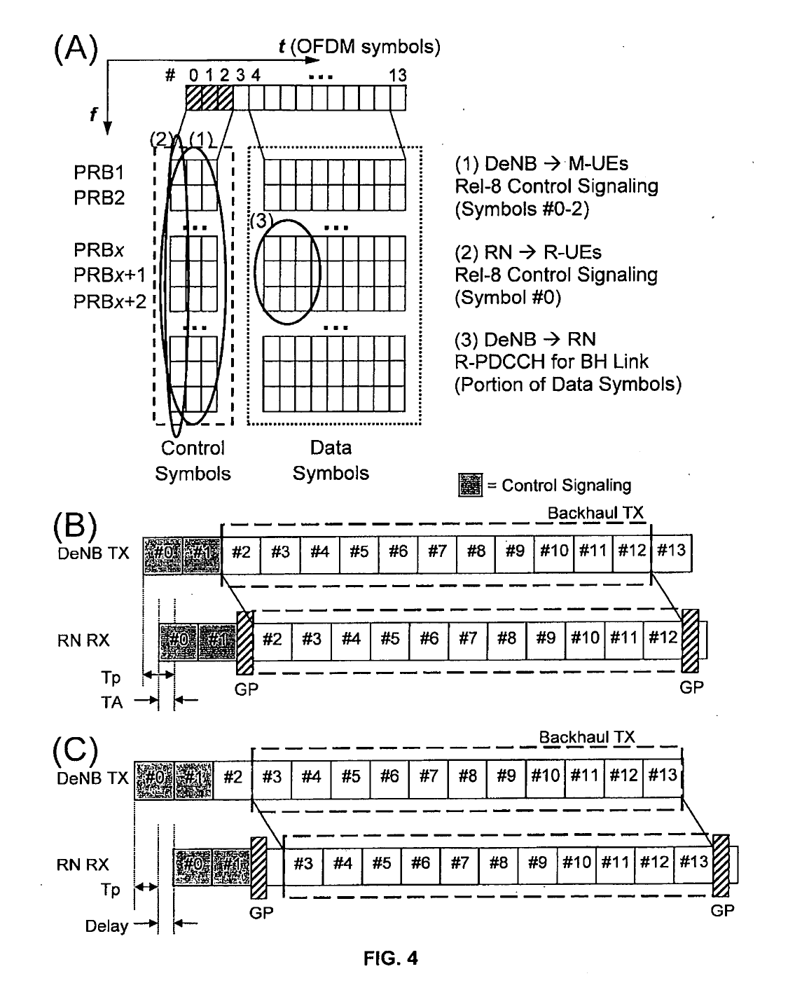

FIG. 3 illustrates an example of a relay node as proposed for the LTE-A system.

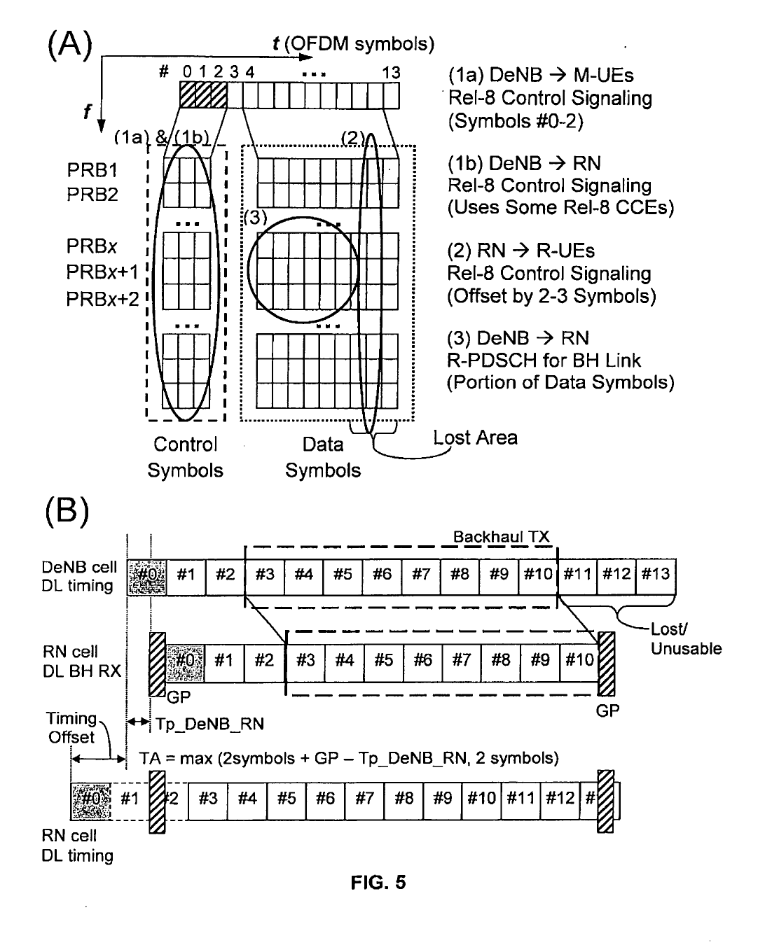

FIG. 4 shows an example of the resource usage and timing for control signaling with a R-PDCCH.

FIG. 5 shows an example of the resource usage and timing for control signaling with a timing offset for the RN cell DL timing.

FIGS. 6-10 illustrate the issues with regards to the second technique shown in FIG. 5.

FIG. 11 shows a simplified block diagram of various exemplary electronic devices that are suitable for use in practicing the exemplary embodiments of this invention.

FIG. 12 shows an example of timing for fine tuning in accordance with the exemplary embodiments of the invention, including Proposal 1.

FIG. 13 illustrates a first exemplary resource usage for use in accordance with the exemplary embodiments of the invention, including Proposal 2a.

FIG. 14 illustrates a second exemplary resource usage for use in accordance with the exemplary embodiments of the invention, including Proposal 2a.

FIG. 15 illustrates an exemplary resource usage for use in accordance with the exemplary embodiments of the invention, including Proposal 2b.

FIG. 16 illustrates an exemplary embodiment of Proposal 2b, including interleaving and mapping, wherein the DeNB transmits Rel-8 DL control signaling to the RN(s) during symbols #0-2.

FIG. 17 shows an example of power shifting as applied to the exemplary embodiment depicted in FIG. 16.

FIG. 18 reproduces section 6.3.1 from TS 36.104, V9.2.0 (2009-12).

FIG. 19 shows an exemplary embodiment of the invention that combines aspects of the other proposals (Proposals 2a and 2b).

FIG. 20 is a logic flow diagram that illustrates the operation of an exemplary method, and a result of execution of computer program instructions embodied on a computer readable memory, in accordance with the exemplary embodiments of this invention.

FIG. 21 is a logic flow diagram that illustrates the operation of another exemplary method, and a result of execution of computer program instructions embodied on a computer readable memory, in accordance with the exemplary embodiments of this invention.

### DETAILED DESCRIPTION

As noted above, for LTE-A the wireless DL backhaul link will be backwards compatible with Rel-8 to enable compatibility with Rel-8 UEs and enable a smoother transition between the technologies. With this backwards compatibility in mind, it is important to design adequate DL control for the backhaul. Reference in this regard may be made to U.S. patent application Ser. No. 12/390,267, filed in February 2009.

One exemplary technique (“the first technique”) that has been considered is to design new control channels for the backhaul (e.g., R-PDCCH). As a non-limiting example, the new control channels may be located in the Rel-8 data region (e.g., Rel-8 PDSCH), for example, to ensure that the new control channel causes a minimum amount of interference with the Rel-8 operations. Such an exemplary design will, to some extent, improve the control channel performance and allow adjustment of RN cell DL timing to maximize the number of available symbols for the backhaul. Reference in this regard may be made to R1-091763, “Control Channel for Relay Backhaul link,” Nokia Siemens Networks, Nokia, 3GPP TSG RAN WG1 Meeting #57, San Francisco, US (May 2009).

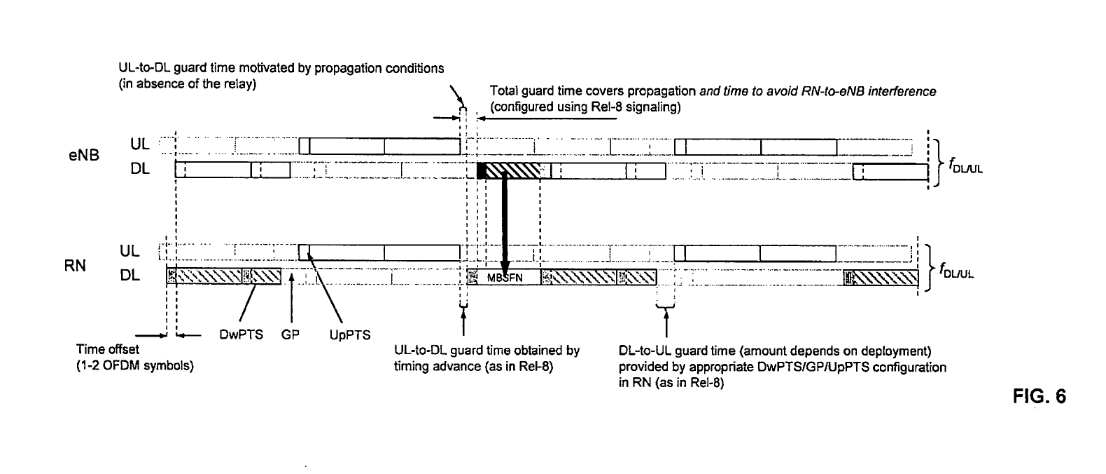

FIG. 4 shows an example of the resource usage and timing for control signaling with a R-PDCCH. In FIG. 4A, the DeNB sends Rel-8 control signaling to the M-UEs in symbols #0-2 (the first three symbols; (1)). The RN sends Rel-8 control signaling to the R-UEs in symbol #0 (the first symbol; (2)). An area within the region (data symbols) that was previously allocated for Rel-8 PDSCH is now specified for the R-PDCCH (3). Note that two or three symbols could be used for Rel-8 control signaling (FIG. 4A shows three symbols).

If the DeNB and RN transmit two symbols (#0 and #1) for Rel-8 control signaling, the Rel-10 control signaling (R-PDCCH, for the BH) could start in symbol #2 (if a TA is used to adjust the DL cell timing of the RN, see FIG. 4B) or symbol #3 (if a delay is used to adjust the DL cell timing of the RN, see FIG. 4C). In such a case (i.e., two symbols of control signaling), the TA and delay methods provide a same BH frame efficiency of 11 symbols. As an example, if three symbols of control signaling are used, the TA method can only use 10 symbols for the BH transmission.

As can be seen in FIG. 4C, the TA method allows for a same DL cell timing for both the DeNB and the RN by removing the propagation delay. This may help LTE-A features that benefit from network synchronization. As an example, a GP of about 10 μs may be utilized (e.g., needed) to allow the RN to switch from transmission (TX) to reception (RX) (e.g., at/before the start of the BH transmission) and vice-versa (e.g., at/after the end of the BH transmission).

Another technique (“the second technique”) that is under consideration is to completely reuse the Rel-8 PDCCH design for the backhaul by introducing a symbol timing offset (in advance) to the RN cell DL timing (e.g., on the order of 1-3 symbols). Such reuse may make the design of eNBs simpler for further releases (e.g., Rel-10/LTE-A) and, thus, reduce the standardization and implementation cost/effort for relay features. Reference in this regard may be made to R1-094449, “On the use of PDCCH for relaying,” Ericsson, ST Ericsson, 3GPP TSG RAN WG1 Meeting #59, Miyazaki, Japan (October 2009).

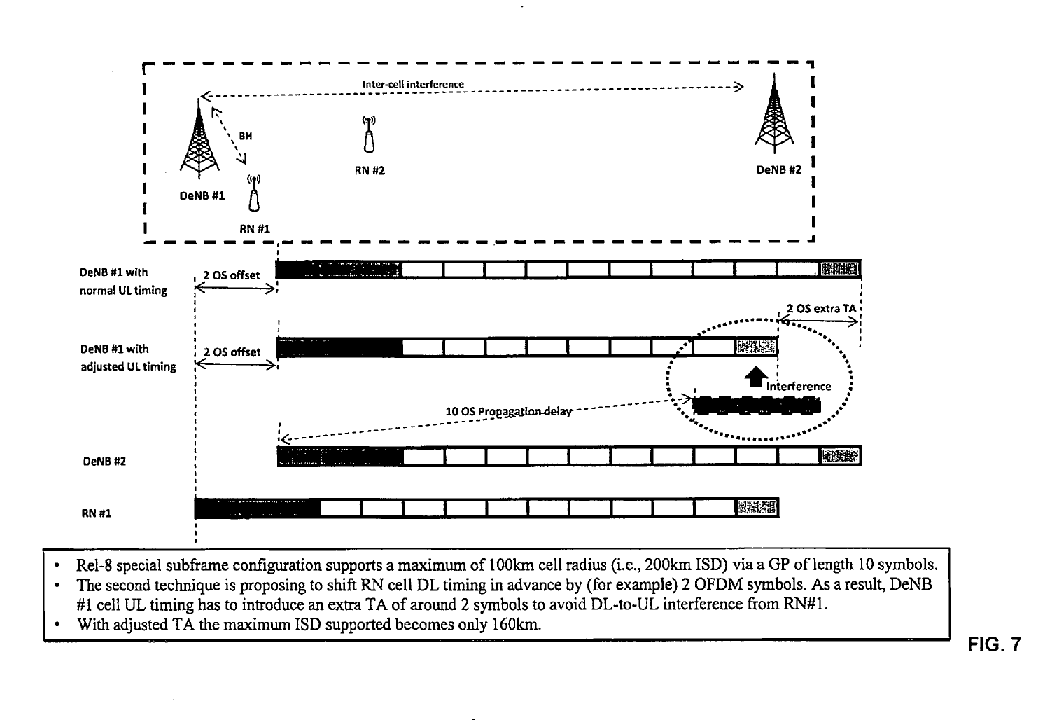

FIG. 5 shows an example of the resource usage and timing for control signaling with a timing offset for the RN cell DL timing. With the second technique, there is no new control signaling on the backhaul link. The Rel-8 control signaling is reused, for example, with a new format. As shown in FIG. 5B, with the RN cell DL timing offset by about 2 symbols the RN can transmit DL control in its own cell in symbols #0 and #1 (see the RN cell DL timing). Afterwards, the RN switches from TX to RX and prepares to receive from the DeNB. In symbols #0-2 (see the RN cell DM BH RX in FIG. 5B), the RN can receive Rel-8 DL control signaling from the DeNB. Note that in these symbols the BH DL control signaling may be multiplexed with DL control for the macro cell (i.e., the signaling sent from the DeNB to the M-UEs in the donor cell), which is as specified in Rel-8 standardization (see TS 36.211, TS 36.212 and TS 36.213).

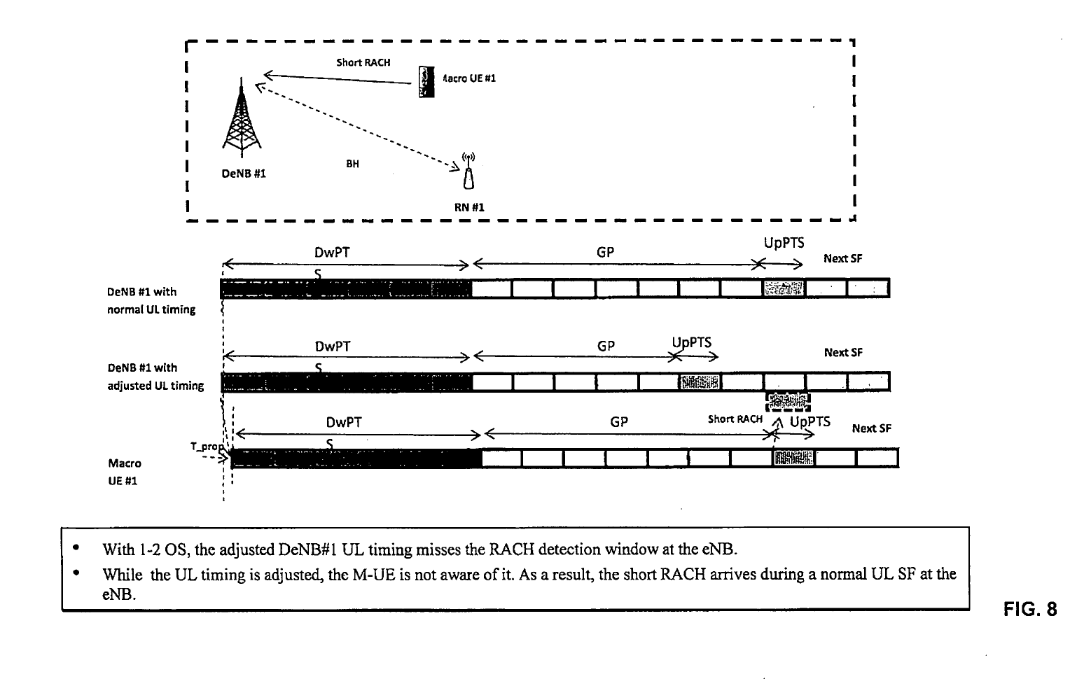

There are a few issues with the second technique, however. In TDD systems, the offset of the RN cell DL timing may cause interference with the donor cell or other neighboring cells (e.g., when these cells are still in an UL subframe). This kind of interference will impact the whole cell and, thus, can be very severe. To avoid such interference, all of the neighboring cells would have to introduce an extra timing advance in their UL effectively to create a GP in the UL-to-DL switching interval. This has an impact from a network signaling/deployment point of view since the DeNB (e.g., DeNB #1) would have to inform all of the other cells (neighboring cells) of the access of the RN in its cell. Even eNBs that do not support relaying would have to implement the extra timing advance in order to avoid the interference. Thus, usage of the second technique would affect all of the local cells and, in some cases, may make it necessary to upgrade many eNBs that are in the vicinity of the DeNB. In addition, such a timing advance will effectively reduce the maximum inter-site distance supported by TDD systems by eating away at the maximum timing advance. Furthermore, usage of the second technique would make usage of the short PRACH feature impossible for a TDD special subframe. In addition, and as can be seen in FIG. 5, usage of the second technique reduces the overall throughput since some of the data symbols are lost or unusable due to the offset of the RN to R-UE Rel-8 control signaling. FIGS. 6-10 illustrate the above-identified issues with regards to the second technique.

In contrast to the first and second techniques noted above, the exemplary embodiments of the invention provide alternative methods and techniques for reusing LTE Rel-8 DL control signaling for the backhaul that do not introduce a relay cell symbol timing offset. In such a manner, various improvements and benefits can be realized including improved compatibility with TDD systems.

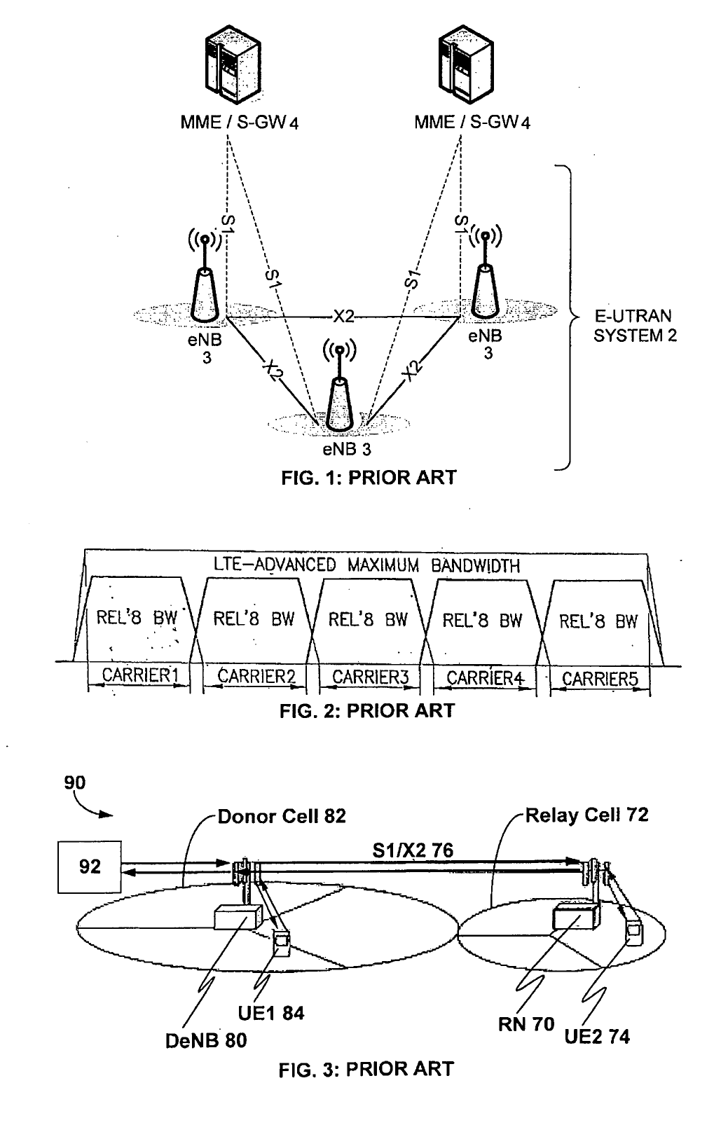

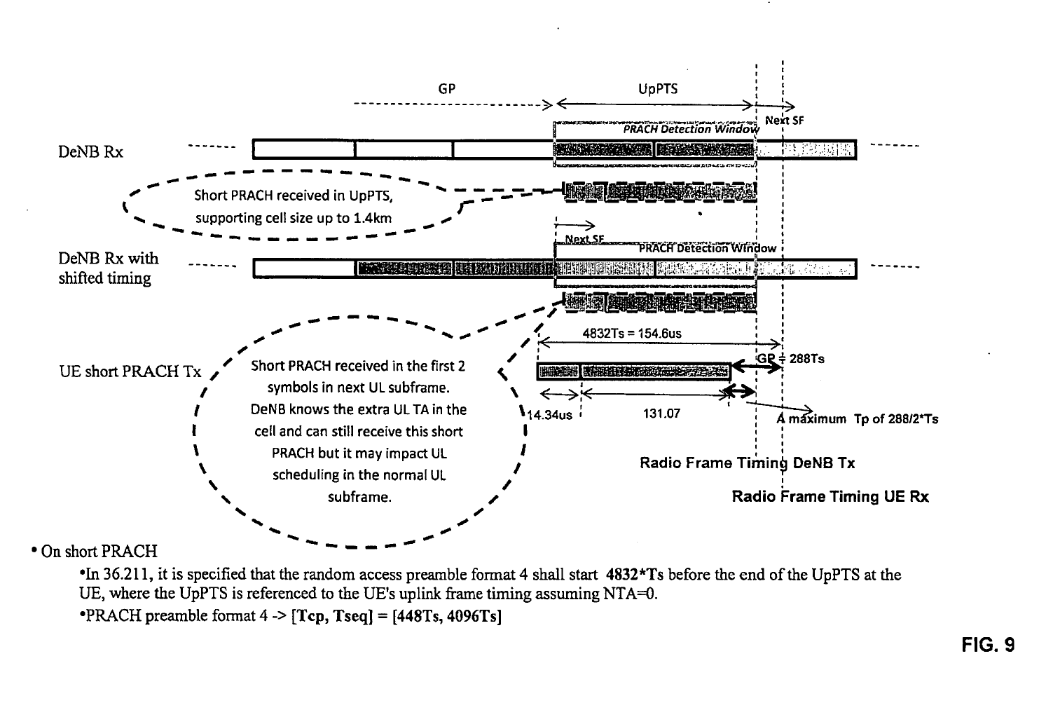

Before describing in further detail the exemplary embodiments of this invention, reference is made to FIG. 11 for illustrating a simplified block diagram of various exemplary electronic devices and apparatus that are suitable for use in practicing the exemplary embodiments of this invention. In FIG. 11, a wireless network 100 is adapted for communication over a wireless link with a plurality of apparatus, such as mobile communication devices which may be referred to as user equipments (UEs), via a network access node, such as a Node B (base station), and more specifically an eNB. The network 100 may include a network control element (NCE) 110 that may include the MMES-GW functionality shown in FIG. 1, and which provides connectivity with one or more other networks, such as a telephone network and/or a data communications network (e.g., the Internet).

The eNB in question may comprise a donor eNB (DeNB) 120 that services a donor cell 125. Within the donor cell 125, a macro UE (M-UE) 130 is (wirelessly) connected to the wireless network 100 via the DeNB 120. The wireless network 100 further includes a relay node (RN) 140 that is wirelessly connected to the wireless network 100 via the DeNB 120. The wireless connection between the RN 140 and the DeNB 120 comprises a backhaul link (BH link) 126. The RN 140 services a relay cell 145 that, in some exemplary embodiments, may be different from the donor cell 125 (e.g., covering different areas or regions). Within the relay cell 145, a relay UE (R-UE) 150 is (wirelessly) connected to the wireless network 100 via the RN 140 and the DeNB 120.

The NCE 110 includes a controller, such as a computer, processor or data processor (DP) 111 and a computer-readable memory medium embodied as a memory (MEM) 112 that stores a program of computer instructions (PROG) 113. As noted above, the NCE 110 is coupled via a data/control path to the DeNB 120. The DeNB 120 may also be coupled to one or more other eNBs (e.g., DeNBs) via another data/control path, which may be implemented as the X2 interface shown in FIG. 1, for example.

The DeNB 120 includes a controller, such as a computer, processor or data processor (DP) 121, a computer-readable memory medium embodied as a memory (MEM) 122 that stores a program of computer instructions (PROG) 123, and a suitable radio frequency (RF) transceiver 124 for communication with the M-UE 130 via one or more antennas. The DeNB 120 is coupled via a data/control path to the NCE 110. As a non-limiting example, the path may be implemented as the S1 interface shown in FIG. 1. The DeNB 120 is also (wirelessly) coupled to the RN 140 via the BH link 126.

The RN 140 includes a controller, such as a computer, processor or data processor (DP) 141, a computer-readable memory medium embodied as a memory (MEM) 142 that stores a program of computer instructions (PROG) 143, and a suitable radio frequency (RF) transceiver 144 for communication with the R-UE 150 via one or more antennas. As noted above, the RN 140 is (wirelessly) coupled to the DeNB 120 via the BH link 126.

The M-UE 130 includes a controller, such as a computer, processor or data processor (DP) 131, a computer-readable memory medium embodied as a memory (MEM) 132 that stores a program of computer instructions (PROG) 133, and a suitable radio frequency (RF) transceiver 134 for bidirectional wireless communications with the DeNB 120 via one or more antennas. The M-UE 130 is located within the donor cell 125 and, thus, is serviced by the DeNB 120.

The R-UE 150 includes a controller, such as a computer, processor or data processor (DP) 151, a computer-readable memory medium embodied as a memory (MEM) 152 that stores a program of computer instructions (PROG) 153, and a suitable radio frequency (RF) transceiver 154 for bidirectional wireless communications with the RN 140 via one or more antennas. The R-UE 150 is located within the relay cell 145 and, thus, is serviced by the RN 140. In some exemplary embodiments, the R-UE 150 is similar or identical (e.g., in composition) to the M-UE 130.

At least one of the PROGs 113, 123, 133, 143, 153 is assumed to include program instructions that, when executed by the associated DP 111, 121, 131, 141, 151 enable the respective device(s) to operate in accordance with the exemplary embodiments of this invention, as will be discussed below in greater detail.

That is, the exemplary embodiments of this invention may be implemented at least in part by computer software executable by the DP 121 of the DeNB 120, by the DP 141 of the RN 140, by the DP 131 of the M-UE 130 and/or by the DP 151 of the R-UE 150, or by hardware, or by a combination of software and hardware (and firmware).

In general, the various embodiments of the UEs (M-UE 130 and/or R-UE 150) can include, but are not limited to, mobile nodes, mobile stations, mobile phones, cellular phones, personal digital assistants (PDAs) having wireless communication capabilities, mobile routers, relay stations, relay nodes, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 112, 122, 132, 142, 152 may be of any type suitable to the local technical environment and may be implemented using any suitable data storage technology, such as semiconductor-based memory devices, flash memory, magnetic memory devices and systems, optical memory devices and systems, fixed memory and removable memory, as non-limiting examples. The DPs 111, 121, 131, 141, 151 may be of any type suitable to the local technical environment, and may include one or more of general purpose computers, special purpose computers, microprocessors, digital signal processors (DSPs) and processors based on a multicore processor architecture, as non-limiting examples.

It should be noted that the devices described above in reference to FIG. 11 may include more than one transceiver and/or more than one antenna. As a non-limiting example, the DeNB 120 may include a plurality of transceivers that enable the DeNB 120 to simultaneously send communications to the M-UE 130 and the RN 140.

For the purposes of describing this invention, the wireless network 100 may be assumed to be compatible with 3GPP LTE Rel-8 and later releases thereof (beyond Rel-8), such as LTE-A. However, these exemplary embodiments are not limited for use with only these particular wireless communications systems and/or protocols.

While described above in reference to memories, these components may generally be seen to correspond to one or more storage devices, storage circuits, storage components and/or storage blocks. In some exemplary embodiments, these components may comprise one or more computer-readable mediums, one or more computer-readable memories and/or one or more program storage devices.

While described above in reference to processors, these components may generally be seen to correspond to one or more processors, data processors, processing devices, processing components, processing blocks, circuits, circuit devices, circuit components, circuit blocks, integrated circuits and/or chips (e.g., chips comprising one or more circuits or integrated circuits).

The exemplary embodiments of the invention include three proposals for new ways to reuse LTE Rel-8 DL control design for the backhaul without a relay cell symbol timing offset. These three proposals are referred to below as Proposal 1, Proposal 2a and Proposal 2b (since Proposals 2a and 2b are related). It should be appreciated that these designations of the proposals are for convenience and discussion purposes, and that various aspects of the individual proposals may be utilized in conjunction with different or other proposals and/or aspects of the exemplary embodiments of the invention (e.g., where suitable, practicable and/or feasible).

### Proposal 1:

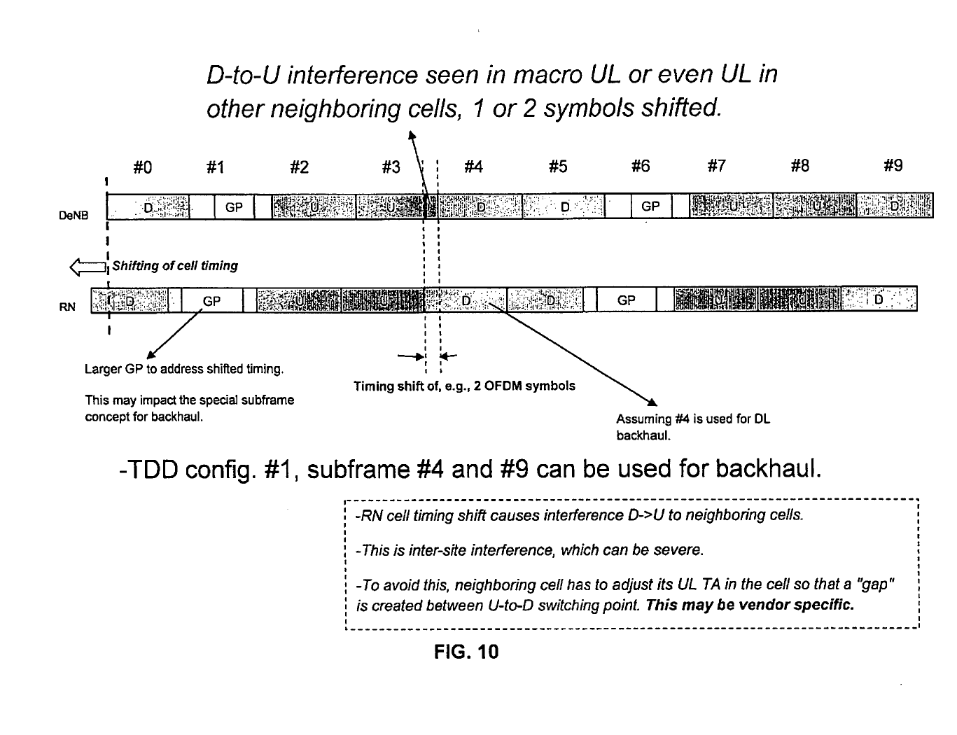

Instead of a symbol level timing offset in the RN cell relative to the donor cell for the DeNB (see, e.g., the second technique described above), some fine tuning is used to account for propagation delay and the TX-to-RX switching for the RN. An example of this fine tuning is shown in FIG. 12. The RN cell DL timing is basically (e.g., substantially, approximately) aligned with that of the DeNB cell using a timing advance of To=GP−Tp_DeNB_RN. The GP is the switching time for the RN (e.g., typically less than 20 μs) and Tp_DeNB_RN is the propagation delay from the DeNB to the RN.

Using this setup, the RN can receive from the DeNB from symbol #2 on. Note that symbol #13 is not available due to the RN's RX-to-TX switching before the next SF. Symbol #13 can be used to absorb both switching times, the TX-to-RX via the timing advance and the RX-to-TX directly. In the example of FIG. 12, any control information mapped to symbol #2 will be accessible to the RN.

Since there is only a slight timing offset instead of symbol level misalignment, the above-noted issues for TDD systems (e.g., with respect to the second technique) can be avoided. That is, there is no impact on the short RACH and the maximum DeNB-RN ISD is preserved. It should be noted that the interference of the RN with neighbor eNBs/cells is also delayed via the propagation delay similar to Tp_DeNB_RN, though for other neighbors this time will be slightly different. Since the GP is small, there will not be any impact if GP<2×Tp_DeNB_RN. Otherwise there is a very small time where there can be interference of GP−2×Tp_DeNB_RN. Note that this interference is much smaller than the one or two symbols of interference as in the second technique.

### Proposal 2a:

The Rel-8 control design for the backhaul based on the timing setting is reused. In symbol(s) #0-#x where x<N_MAX_PDCCH, the DeNB transmits DL control signaling to the M-UEs, while in symbol(s) #(x+1)−#(x+N_MAX_PDCCH_RN) the DeNB transmits DL backhaul control signaling to the RN(s) by completely following the Rel-8 designs in terms of CCE-based interleaving and mapping. N_MAX_PDCCH is the maximum possible number of symbols for DL control to the M-UEs. As non-limiting examples, N_MAX_PDCCH can be set to 1, 2 or 3 according to Rel-8. N_MAX_PDCCH_RN is the maximum possible number of symbols for DL backhaul control. This proposal can provide fully flexible multiplexing of DL control for the M-UEs and DL control for the backhaul in the data region by semi-statically configuring the backhaul control searching space to be only a portion of the bandwidth.

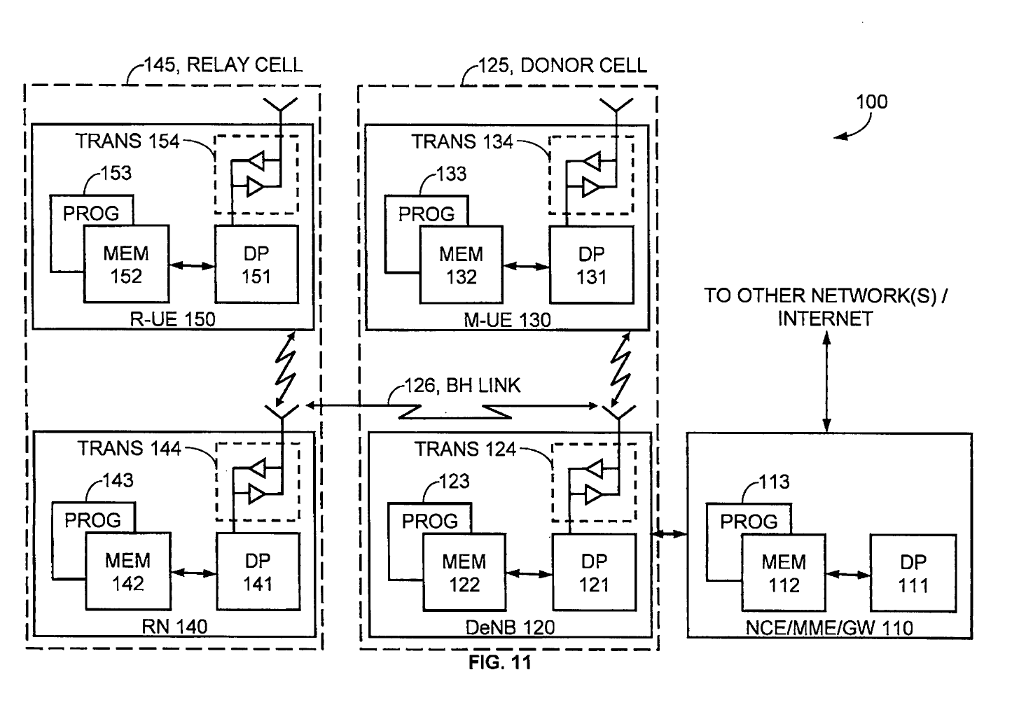

FIG. 13 illustrates a first exemplary arrangement for Proposal 2a. The DeNB transmits DL control to the M-UEs in symbols #0-1. The RN transmits DL control to the R-UEs in symbol #0 (or in symbols #0-1). In symbol #2, the DeNB transmits backhaul control to the RN, following Rel-8 DL control design in terms of CCE-based interleaving and mapping. Note that the backhaul control is transmitted in symbol #2 and not in symbol #0 (symbol #0 being in accordance with Rel-8). In the DeNB cell (the donor cell), the PCFICH will be set to 1 or 2, indicating the number of symbols to be used for DL control in LTE Rel-8. For the exemplary embodiment depicted in FIG. 13, it may be said either that there is no R-PDCCH or that the R-PDCCH is in the form of Rel-8 control. For example, in terms of resources it may be mapped as (3) in FIG. 13 and, while following Rel-8 designs, it may be mapped to the symbol that is accessible by the RN (e.g., symbol #2).

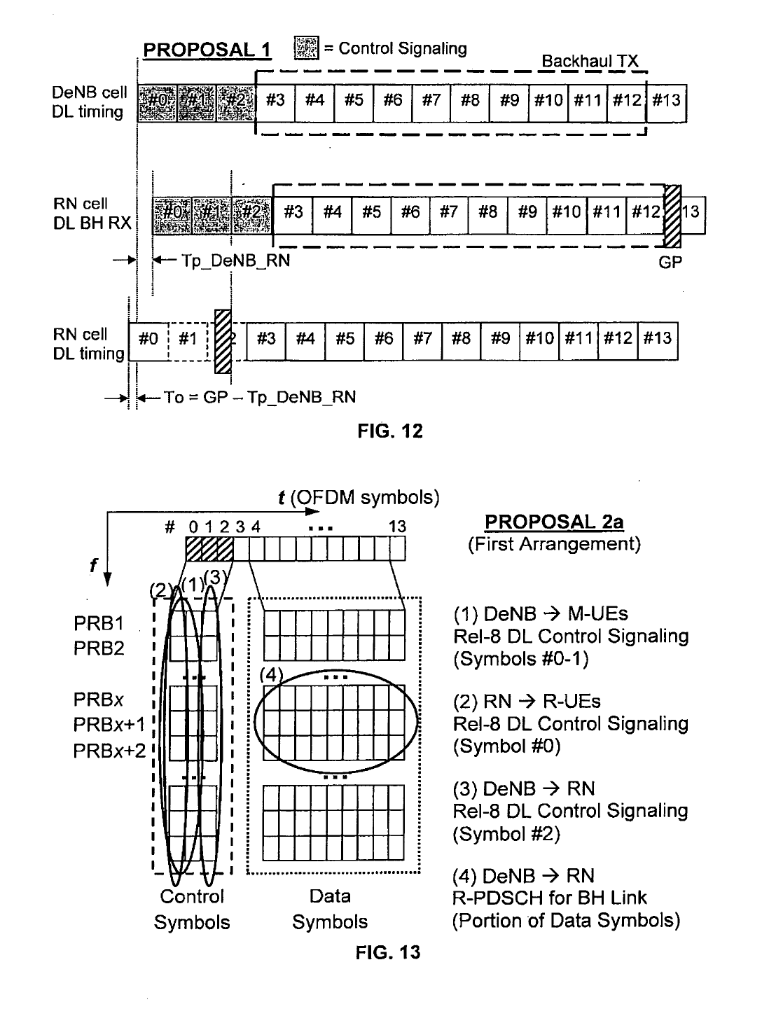

FIG. 14 shows a second exemplary arrangement for Proposal 2a. The second arrangement supports macro DL and backhaul multiplexing in the SF. The DeNB will semi-statically configure the searching space for the backhaul control to be only part of the bandwidth (e.g., continuous PRBs, distributed PRBs), as shown by (3). The remainder of the bandwidth, e.g., (2), can be used to schedule macro DL transmissions. In the backhaul control (3), the resource allocation for the backhaul data (4) will be indicated.

As shown in FIG. 14, Proposal 2a can support multiplexing of the backhaul and macro DL transmissions. The resources for both can be semi-statically adjusted according to traffic status in the macro/donor and RN cells. While shown in FIG. 14 with a portion for macro transmissions (2), these resources can be used for other transmissions (e.g., in addition to or instead of macro DL transmissions). For example, RN data can be transmitted in this portion. This provides for flexible division of the data resources, even if the portion of PRBs assigned to the R-PDCCH (3) is configured in a coarse fashion. This could be extended for a fully dynamic adjustment, for example, if the portion of PRBs for relays is transmitted in each SF (e.g., in a specific area of the OFDM symbol, such as at the upper band edge, which is commonly used to serve relays).

Another option is to select the CCEs for relays in a smart way so that they do not affect some PRBs. In such a manner, Rel-8 UEs could be scheduled in those PRBs despite the fact that the PRBs are within the RN control area (though that particular portion of the control area is blank). However, this would require smart allocation of the CCEs for the RN and, in turn, may incur more blind decoding attempts from the RN. If only a few RNs are to be scheduled, it may be optimum to ensure that the same PRBs are hit by the RNs' R-PDCCH's (i.e., the REGs of the different RNs overlap as much as possible). In this way, the maximum number of PRBs would be available for the M-UEs. In the alternative, if only a few UEs are to be scheduled (e.g., because they have very delay sensitive service and, therefore, should not be delayed to the next TTI), then only a few PRBs need to be exempted from the R-PDCCH (i.e., the REGs falling in these PRBs are left blank for the R-PDCCH).

While Proposal 2a may be considered somewhat similar to the first technique noted above since both describe a new R-PDCCH, Proposal 2a allows for maximal reuse of the PDCCH design (e.g., for Rel-8) and requires fewer changes than for the first technique. Proposal 2a allows for reuse of the Rel-8 control signaling for the RN, but uses a second delayed instance. This may impact the DeNB timing implementation on the C-plane. Proposal 2a supports semi-static resource petitioning between the backhaul and macro DL transmissions.

### Proposal 2b:

Similar to Proposal 2a, Proposal 2b also reuses the Rel-8 control design for the backhaul based on the timing setting. In symbol(s) #0-#x where x<N_MAX_PDCCH, the DeNB (substantially) simultaneously transmits DL control signaling to the M-UEs and DL backhaul control signaling to the RN(s). The control channels for the M-UEs and RN(s) are multiplexed in these symbols, completely following the Rel-8 designs in terms of CCE-based interleaving and mapping. This proposal can provide fully flexible multiplexing of DL control for the M-UEs and DL control for the backhaul.

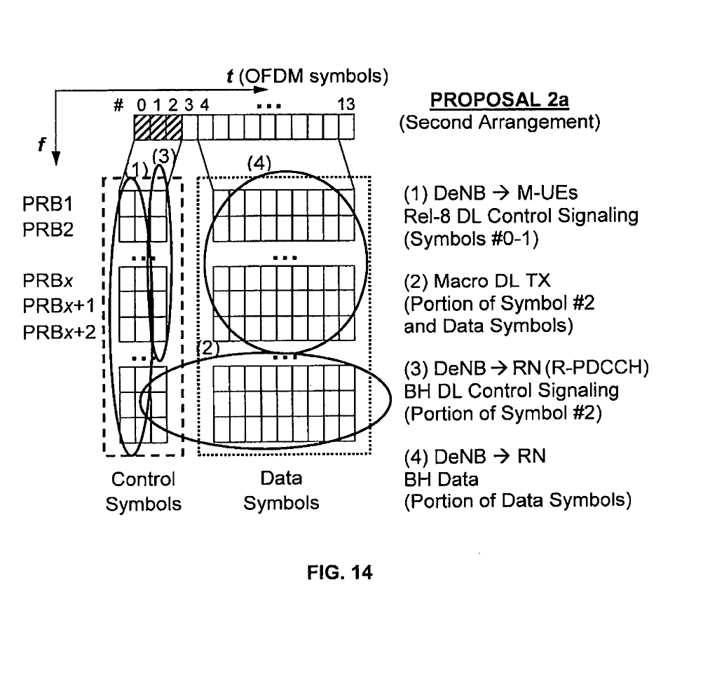

As can be seen in the example shown in FIG. 15, the DeNB transmits Rel-8 DL control signaling (1) to the M-UEs in symbols #0-2. The RN transmits Rel-8 DL control signaling (2) to the R-UEs in symbol #0 then switches from TX-to-RX (e.g., in symbol #1). The DeNB effectively transmits Rel-8 DL control signaling (3) to the RN(s) at least during symbol #2 (e.g., during symbols #0-2). A portion of the data symbols is used for a R-PDSCH (4) that is transmitted from the DeNB to the RN(s).

Note that in some exemplary embodiments, the DeNB may transmit the Rel-8 DL control signaling (3) to the RN(s) during symbols #0-2. Note that in such a case, the RN will not be able to receive the control signaling from the DeNB during symbols #0-1. In other exemplary embodiments, by utilizing fine tuning for the RN cell timing (e.g., as in FIG. 12), the RN may be able to transmit control information to the R-UEs in the first two symbols (e.g., symbols #0-1).

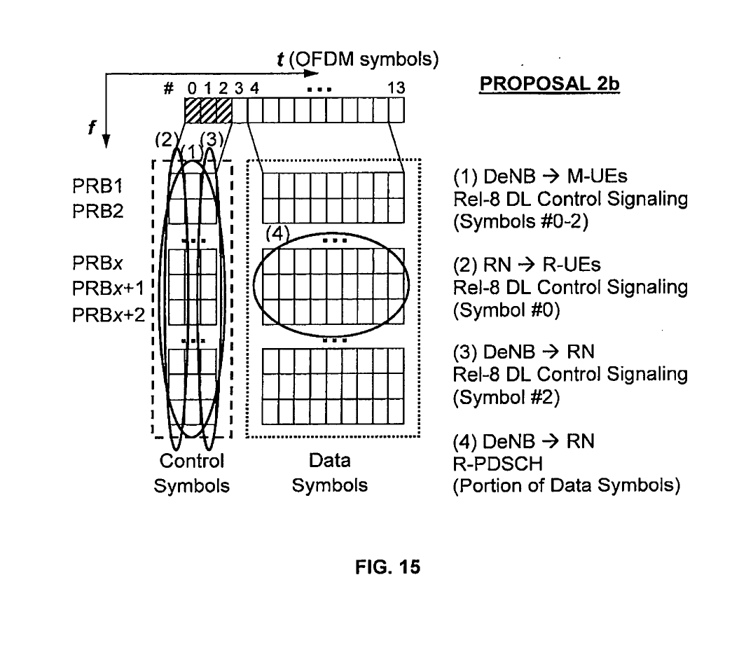

FIG. 16 illustrates an exemplary embodiment of Proposal 2b wherein the DeNB transmits Rel-8 DL control signaling to the RN(s) during symbols #0-2. Following Rel-8, the coded bits for backhaul control are first arranged in REGs (e.g., REGs 1, 2, 3). The REGs for all RNs and M-UEs are then jointly interleaved according to a predefined pattern. The interleaved REGs are mapped to physical resources (e.g., in a time-first manner). Since the portion of RN DL control signaling that falls within the first two symbols (REGs 1 and 2 which are mapped to elements in symbols #0-1) is unavailable to the RN(s), dummy bits can be inserted into these REGs (e.g., as compared to not transmitting anything during symbols #0-1). Alternatively, the DeNB can configure the effective coding rate for the backhaul control to be high enough for achieving the control performance target even with 2/3 puncturing.

As is apparent from the above description of FIG. 16, the RN(s) need to be able to decode the control signaling (e.g., the PDCCH) from only one third of the total REs (e.g., only from symbol #2 out of symbols #0-2). In some exemplary embodiments, the decoding probability can be enhanced by boosting the power of the RN's REs in that symbol (symbol #2). However, since the total transmit power of an amplifier is limited, and because it is desirable to limit the interference with the other cells, boosting the power of certain REs may be possible only if power for other REs (e.g., REs for the UEs, such as the M-UEs) is reduced accordingly. While this may degrade the performance of the UE transmissions, it may be possible to compensate for this degradation by boosting the power for the UEs' REs in the other symbols at the expense of the RN's dummy REs (i.e., those REs in the first two symbols, symbols #0-1, that are filled with dummy bits). Since the RN cannot receive the dummy REs in the first two symbols, there is no harm in shifting power from the dummy REs (e.g., completely redistributing their power) to REs for the UEs in those symbols. This can counterbalance the loss of quality due to taking power away from the UEs' REs in the third symbol. In total, it is likely that the UEs will gain more power than they lose. Furthermore, this can also compensate for the uneven balance of quality among the different REs. In addition, if there are more (e.g., significantly more) UEs than RNs and consequently more REs allocated to UEs than RNs, then each UE will only suffer a little from the loss of power in the third symbol's REs (e.g., the loss is amortized over the larger set of UEs).

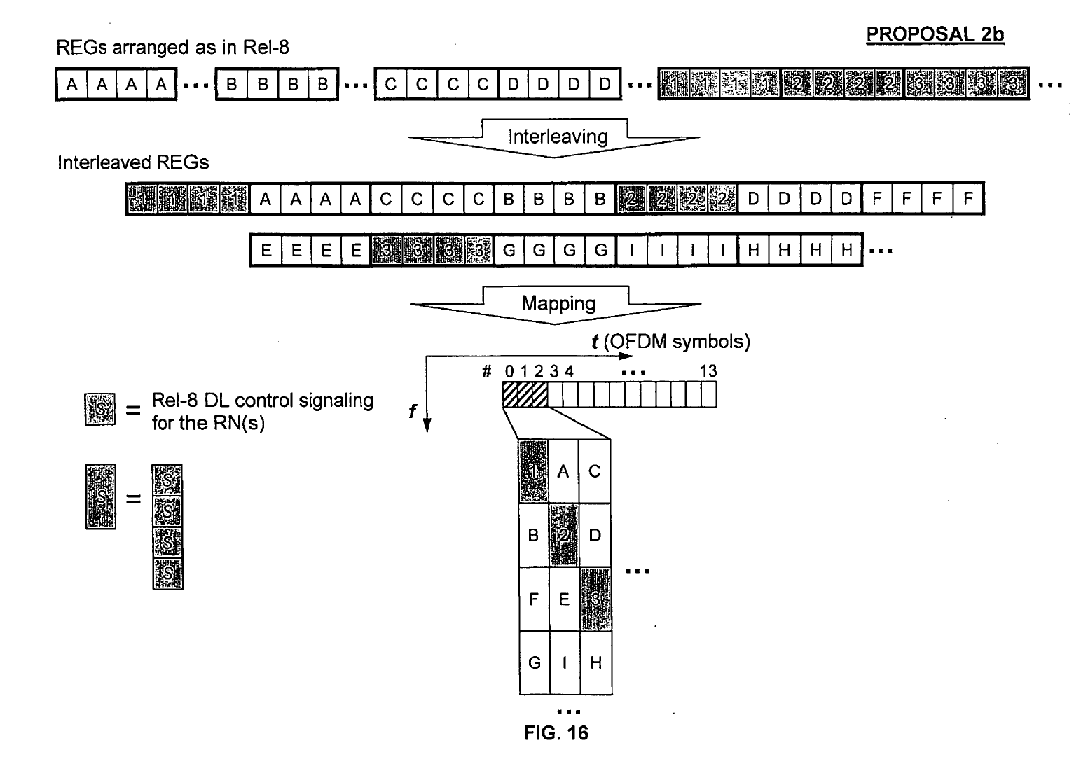

FIG. 17 shows an example of the power shifting as applied to the exemplary embodiment depicted in FIG. 16. In symbols #0-1, power is shifted from the REs for the Rel-8 DL control signaling to the REs for the UEs. Since the control signaling in symbols #0-1 contains dummy bits, and further since the RN is not expected to receive the control signaling in symbols #0-1, this loss of power does not pose a problem. In some exemplary embodiments, the power may be substantially (e.g., entirely) removed from the control signaling in symbols #0-1 and redistributed to the UEs (e.g., the Rel-8 DL control signaling from the DeNB to the M-UEs). In contrast to symbols #0-1, in symbol #2 the power of the DeNB-to-RN Rel-8 DL control signaling is boosted by shifting power from the UEs' REGs.

The extra power that becomes available for the RN's PDCCH then may enable usage of a higher coding rate or a higher modulation alphabet (e.g., 16QAM or 8PSK instead of QPSK), thus boosting performance (e.g., enabling the achievement of performance gains or an improvement in performance). If a phase modulation scheme (e.g., 8PSK) is used, this can be done without setting a predetermined power ratio between the reference signals and the RN's REs because the amplitude does not carry any information for phase modulation. If higher order QAM modulation is used, then it would be desirable to use a fixed power ratio between the reference signals and the PDCCH REs in order to allow the RN to properly decode the amplitude modulation. This may require that the power for these REs be predetermined and this in turn may require that the necessary power be taken from the UEs' REs in the third symbol (symbol #2) no matter how much they need to be attenuated. In that case, it would not be possible to configure too many RN PDCCHs and concurrent UE PDCHs within a subframe without compromising the UEs' performance. Consequently, it may be necessary to limit the number of such concurrent PDCCHs or to limit the amount of power boosting.

In order to precisely predict the power that will be available for the RN (and UEs) for the PDCCH, it may be necessary to calculate how many REs will fall into the first, second and/or third OFDM symbols and take this into account when setting the power level of the REs appropriately. However, as the distribution is pretty uniform, standard values can be used instead, taking into account the number of REs used for scheduling RNs and UEs and/or the number of REGs that are assigned to UEs and/or RNs.

Since the dummy REs are not received by the RN, their actual content is irrelevant. As an example, the dummy REs can be explicitly set to a predetermined value, possibly a predetermined “place-holder value” that is sometimes referred to as “NIL”. As another example, the dummy REs can be loaded with the bits that would be transmitted if the PDCCH was sent in the standard way to a UE. The latter of these examples offers to reuse the standard processing algorithms in the eNB, as detailed above. However, using NIL values may be a convenient way to mark the REs that are supposed to be transmitted with zero power or at least reduced power later on.

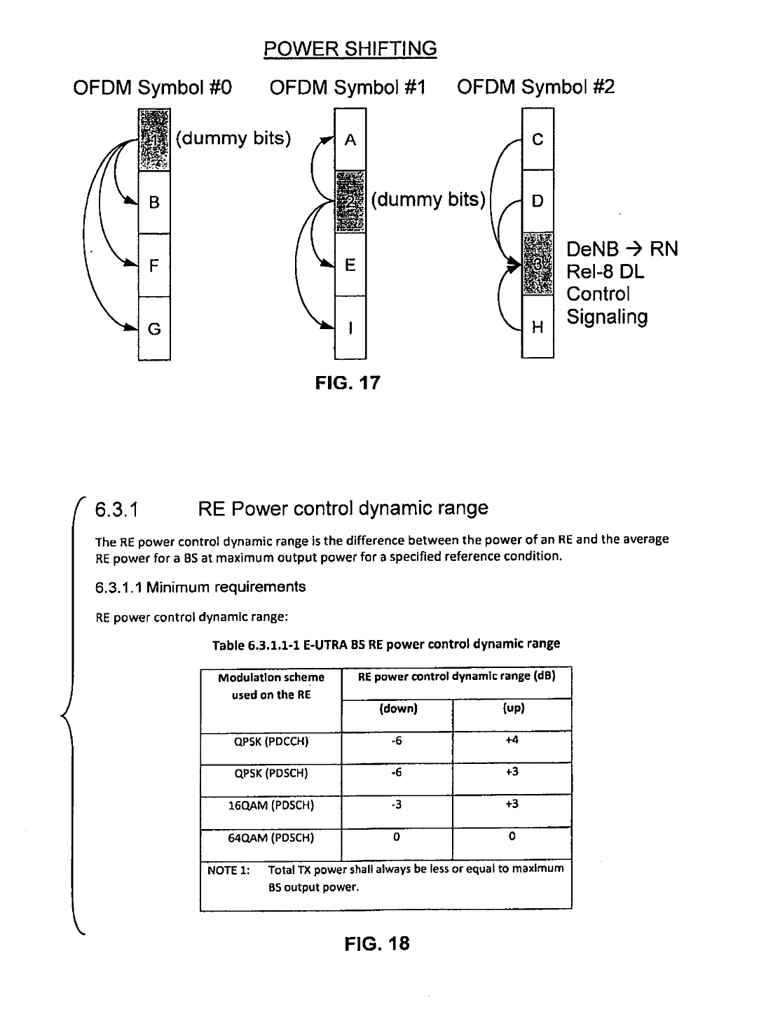

It should be noted, that power variations are already allowed for the PDCCH according to TS 36.104, V9.2.0 (2009-12), “3rd Generation Partnership Project; Technical Specification Group Radio Access Network; Evolved Universal Terrestrial Radio Access (E-UTRA); Base Station (BS) radio transmission and reception (Release 9)”. For example, section 6.3.1 allows a dynamic control range of −6 dB up to +4 dB for the PDCCH (i.e. power boosting by more than double or reduced power down to a quarter). This range should be sufficient for the power adaptation discussed herein. It should be noted that if the number of UEs is significantly smaller than the number of RNs then a different power adaptation range and/or technique should be considered. For reference purposes, FIG. 18 reproduces section 6.3.1 from TS 36.104, V9.2.0 (2009-12).

While described above with respect to the usage of dummy bits for symbols #0-1, in other exemplary embodiments the REs in these symbols may be used for a different purpose and the REs may be utilized to transmit information or data, including control information (e.g., to Rel-10 UEs), as a non-limiting example.

Proposal 2b allows for reuse of Rel-8 control signaling for the RN without a time offset. Furthermore, there is no impact on the DeNB timing implementation on the C-Plane. In addition, the R-PDSCH can reuse the PDSCH mapping, even without any delay. Proposal 2b also supports fully flexible multiplexing between the backhaul and macro DL transmissions.

### Combination of Proposals 2a and 2b:

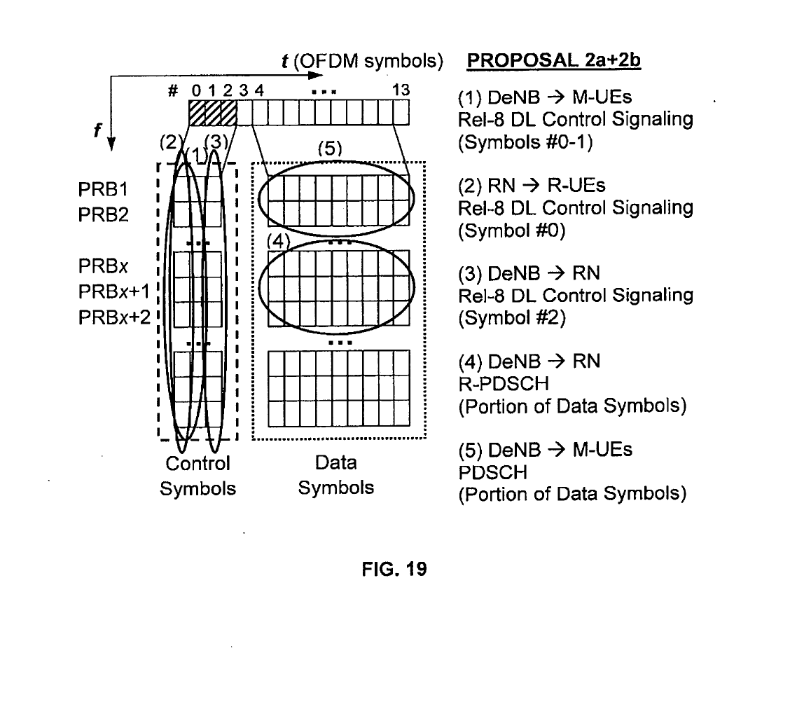

In some exemplary embodiments, it may be possible to combine aspects of the above-described proposals (Proposals 2a and 2b). FIG. 19 shows an exemplary embodiment of the invention that combines aspects of the above-described proposals (Proposals 2a and 2b). The DeNB transmits Rel-8 DL control signaling (1) to the M-UEs in symbols #0-1. The RN transmits Rel-8 DL control signaling (2) to the R-UEs in symbol #0 (possibly in symbols #0-1) then switches from TX-to-RX (e.g., in symbol #1, via fine tuning). The DeNB effectively transmits Rel-8 DL control signaling (3) to the RN(s) at least during symbol #2 (e.g., during symbols #0-2). A portion of the data symbols is used for a R-PDSCH (4) that is transmitted from the DeNB to the RN(s). Another portion of the data symbols is used for a PDSCH (5) that is transmitted from the DeNB to the M-UEs. As is apparent, no REs are lost in the CCEs of the first two symbols (symbols #0-1).

Thus, the Rel-8 PDCCH for the M-UEs only uses the first two symbols (symbols #0-1) as in Proposal 2a and the RN(s) only receive in the third symbol (symbol #2) as in both proposals. However, the R-PDCCH for the RNs is not a delayed one-symbol version of the Rel-8 PDCCH (as in Proposal 2a) but rather it is in the last symbol of a non-delayed three-symbol Rel-8 PDCCH. The UEs receive the same PDCCH as in Proposal 2a and the RN receives the same R-PDCCH as in Proposal 2b. As compared with Proposal 2a, the R-PDCCH is not delayed (reuses timing), but the first two symbols need to be inhibited (the Rel-8 PDCCH takes over). As compared with Proposal 2b, there is no loss of bits from relay CCEs in the first symbols, though the instant arrangement sacrifices the option to have both M-UEs and RNs share the PDSCH area. The overall benefits of this combined approach include allowing for dynamic switching between Proposal 2a (or this combined approach) and Proposal 2b and allowing for dynamic scheduling of a mix of M-UEs and/or RNs without any loss. Neither the M-UEs nor the RN(s) need to be aware of which variant is in use in a particular subframe since both appear to be the same from their respective point of view. In addition, neither extra blind decoding nor signaling is needed as the M-UEs will be told by the PCFICH whether to use two or three OFDM symbols.

### Further Exemplary Embodiments

In some of the above-described exemplary embodiments (e.g., those shown in FIGS. 13-15), the Rel-8 DL control signaling sent from the DeNB to the RN is described as occurring at least during symbol #2 (e.g., the third symbol). It should be noted that while in some cases the RN may only be able to receive during symbol #2, in order to completely follow Rel-8 control design for the backhaul the DeNB-to-RN control is transmitted in symbols #0-2 (e.g., during the first three symbols). As noted above, in some exemplary embodiments dummy bits may be used to fill the transmission during symbols #0-1. Also as noted above, in other exemplary embodiments power control may be utilized to cause DTX for symbols #0-1.

In further exemplary embodiments, depending on the RN configuration it may be possible for the RN also to receive during the second symbol (e.g., during both symbols #1 and #2). This may be available, for example, if the RN itself only transmits a single symbol for its own PDCCH and then uses the timing advance method to optimize switching. As another non-limiting example, this may be available if the RN does not send any PDCCH (e.g., a so-called “blank subframe”) but needs one symbol for switching. The techniques, apparatus, programs and methods described herein can be further generalized to a different number of symbols (e.g., more symbols, as is already the case for the PDCCH).

Below are provided further descriptions of various non-limiting, exemplary embodiments. The below-described exemplary embodiments are separately numbered for clarity and identification. This numbering should not be construed as wholly separating the below descriptions since various aspects of one or more exemplary embodiments may be practiced in conjunction with one or more other aspects or exemplary embodiments. That is, the exemplary embodiments of the invention, such as those described immediately below, may be implemented, practiced or utilized in any combination (e.g., any combination that is suitable, practicable and/or feasible) and are not limited only to those combinations described herein and/or included in the appended claims.

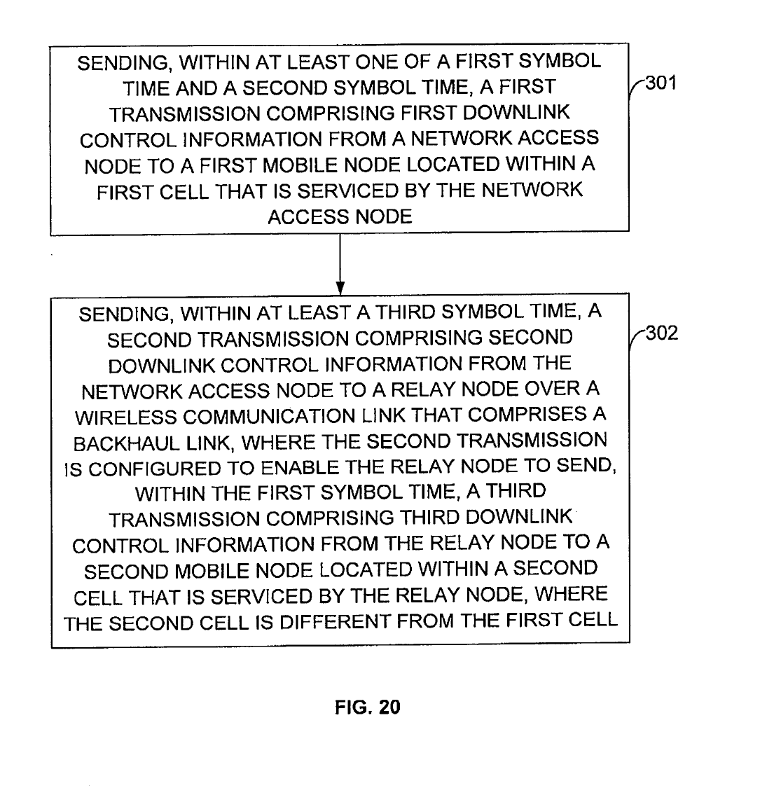

(1) In one exemplary embodiment, and with reference to FIG. 20, a method comprising: sending, within at least one of a first symbol time and a second symbol time, a first transmission comprising first downlink control information from a network access node to a first mobile node located within a first cell that is serviced by the network access node (301); and sending, within at least a third symbol time, a second transmission comprising second downlink control information from the network access node to a relay node over a wireless communication link that comprises a backhaul link, where the second transmission is configured to enable the relay node to send, within (e.g., at least) the first symbol time, a third transmission comprising third downlink control information from the relay node to a second mobile node located within a second cell that is serviced by the relay node, where the second cell is different from the first cell (302).

A method as above, where the first transmission is sent within the first, second and third symbol times. A method as in any above, where the second transmission is sent within the first, second and third symbol times. A method as in any above, where the portions of the second transmission that are sent within the first and second symbol times comprise dummy information. A method as in any above, where power is shifted among different transmissions sent during the first symbol time such that a power of the portion of the second transmission that is sent within the first symbol time is reduced and a power of at least one other transmission sent within the first symbol time is increased. A method as in any above, where the power of the portion of the second transmission that is sent within the first symbol time is reduced to substantially zero.

A method as in any above, where power is shifted among different transmissions sent during the second symbol time such that a power of the portion of the second transmission that is sent within the second symbol time is reduced and a power of at least one other transmission sent within the second symbol time is increased. A method as in any above, where the power of the portion of the second transmission that is sent within the second symbol time is reduced to substantially zero. A method as in any above, where power is shifted among different transmissions sent during the third symbol time such that a power of the portion of the second transmission that is sent within the third symbol time is increased and a power of at least one other transmission sent within the third symbol time is decreased. A method as in any above, where the at least one other transmission sent within the first symbol time, the at least one other transmission sent within the second symbol time and the at least one other transmission sent within the third symbol time comprise downlink transmissions sent from the network access node to at least one mobile node located within the first cell.

A method as in any above, where the second transmission is sent via a physical downlink control channel. A method as in any above, where the second transmission is sent via a relay link (backhaul link) physical downlink control channel. A method as in any above, where the first, second and third symbol times comprise control symbols, where the control symbols are embodied within a frame that further comprises data symbols, the method further comprising: sending a fourth transmission comprising backhaul data from the network access node to the relay node, where the fourth transmission is sent using a portion of the data symbols. A method as in any above, where the fourth transmission is sent via a relay link (backhaul link) physical downlink shared channel.

A method as in any above, where the network access node comprises a base station, a Node B, an evolved Node B or a donor evolved Node B. A method as in any above, where at least one of the first mobile node and the second mobile node comprises a user equipment, portable computer, mobile phone or cellular phone. A method as in any above, where the first, second and third symbol times comprise OFDM symbols. A method as in any above, where the first downlink control information comprises LTE Rel-8 DL control information for the first mobile node. A method as in any above, where the second downlink control information comprises LTE Rel-8 DL control information for the relay node. A method as in any above, where the third downlink control information comprises LTE Rel-8 DL control information for the second mobile node.

A method as in any above, where a downlink relay node cell timing is substantially aligned to a network access node downlink cell timing. A method as in any above, where a timing of the second transmission is configured semi-statically. A method as in any above, further comprising: sending, within at least the first symbol time, the third transmission from the relay node to the second mobile node. A method as in any above, where the method is implemented within a wireless communication system. A method as in any above, where the network access node, the first mobile node, the relay node and the second mobile node comprise nodes within a wireless communication system. A method as in any above, where the wireless communication system comprises an evolved universal terrestrial radio access network. A method as in any above, where the wireless communication system comprises a long term evolution-advanced universal terrestrial radio access network. A method as in any above, where the method is implemented within an evolved universal terrestrial radio access network. A method as in any above, where the method is implemented within a long term evolution-advanced universal terrestrial radio access network.

A method as in any above, implemented as (e.g., performed by) a computer program. A method as in any above, implemented as a computer program stored (e.g., tangibly embodied) on a computer-readable medium (e.g., a program storage device, a memory). A computer program comprising computer program instructions that, when loaded in a processor, perform operations according to one or more (e.g., any one) of the above-described methods. A method as in any above, implemented as a program of instructions tangibly embodied on a program storage device, execution of the program of instructions by a machine (e.g., a processor or a data processor) resulting in operations comprising the steps of the method. A method as in any above, further comprising one or more aspects of the exemplary embodiments of the invention as described elsewhere herein, and, in particular, one or more aspects of the exemplary embodiments of the invention as relating to exemplary methods described herein.

(2) In another exemplary embodiment, a program storage device readable by a machine, tangibly embodying a program of instructions executable by the machine for performing operations, said operations comprising: sending, within at least one of a first symbol time and a second symbol time, a first transmission comprising first downlink control information to a first mobile node located within a first cell that is serviced by the machine (301); and sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell (302).

A program storage device as in any above, where the machine comprises a network access node. A program storage device as in any above, wherein the program storage device comprises a computer-readable medium, a computer-readable memory, a memory, a memory card, a removable memory, a storage device, a storage component and/or a storage circuit. A program storage device as in any above, further comprising one or more aspects of the exemplary embodiments of the invention as described elsewhere herein, and, in particular, one or more aspects of the exemplary embodiments of the invention as relating to exemplary methods described herein.

(3) In another exemplary embodiment, an apparatus comprising: at least one processor; and at least one memory including computer program code, the at least one memory and the computer program code being configured to, with the at least one processor, cause the apparatus at least to perform: sending, within at least one of a first symbol time and a second symbol time, a first transmission comprising first downlink control information to a first mobile node located within a first cell that is serviced by the apparatus; and sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

An apparatus as in any above, further comprising one or more aspects of the exemplary embodiments of the invention as described elsewhere herein, and, in particular, one or more aspects of the exemplary embodiments of the invention as relating to exemplary apparatus described herein.

(4) In another exemplary embodiment, an apparatus comprising: first means for sending, within at least one of a first symbol time and a second symbol time, a first transmission comprising first downlink control information to a first mobile node located within a first cell that is serviced by the apparatus; and second means for sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

An apparatus as above, where the first means for sending and the second means for sending comprise at least one transmitter or at least one transceiver. An apparatus as in any above, further comprising one or more aspects of the exemplary embodiments of the invention as described elsewhere herein, and, in particular, one or more aspects of the exemplary embodiments of the invention as relating to exemplary apparatus described herein.

(5) In another exemplary embodiment, an apparatus comprising: first transmission circuitry configured to send, within at least one of a first symbol time and a second symbol time, a first transmission comprising first downlink control information to a first mobile node located within a first cell that is serviced by the apparatus; and second transmission circuitry configured to send, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

An apparatus as in any above, embodied within at least one integrated circuit device. An apparatus as in any above, further comprising one or more aspects of the exemplary embodiments of the invention as described elsewhere herein, and, in particular, one or more aspects of the exemplary embodiments of the invention as relating to exemplary apparatus described herein.

(6) In another exemplary embodiment, an apparatus comprising: a first transmitter configured to send, within at least one of a first symbol time and a second symbol time, a first transmission comprising first downlink control information to a first mobile node located within a first cell that is serviced by the apparatus; and a second transmitter configured to send, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

An apparatus as in any above, further comprising at least one processor (e.g., coupled to the first transmitter and the second transmitter). An apparatus as in any above, where the at least one processor is configured to compose at least one of the first transmission and the second transmission. An apparatus as in any above, further comprising one or more aspects of the exemplary embodiments of the invention as described elsewhere herein, and, in particular, one or more aspects of the exemplary embodiments of the invention as relating to exemplary apparatus described herein.

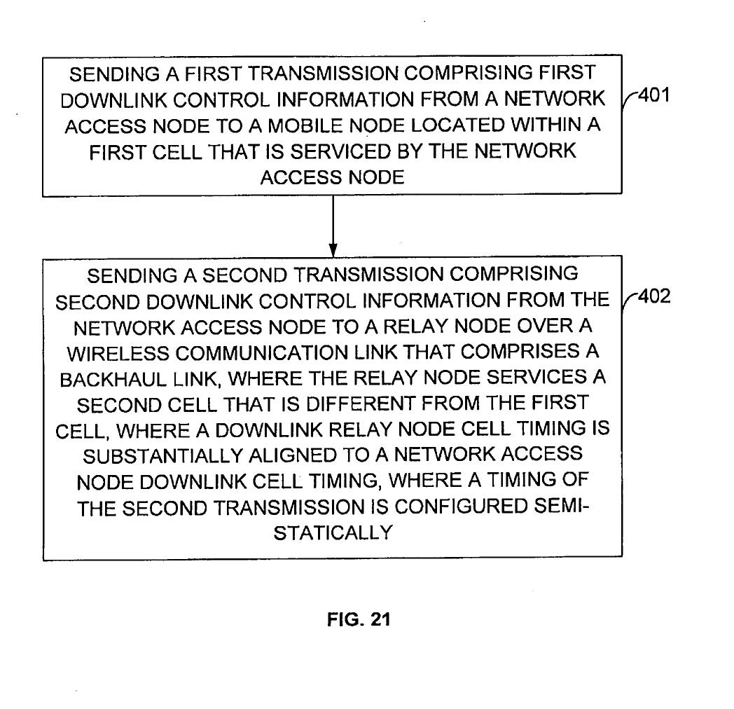

(7) In one exemplary embodiment, and with reference to FIG. 21, a method comprising: sending a first transmission comprising first downlink control information from a network access node to a mobile node located within a first cell that is serviced by the network access node (401); and sending a second transmission comprising second downlink control information from the network access node to a relay node over a wireless communication link that comprises a backhaul link, where the relay node services a second cell that is different from the first cell, where a downlink relay node cell timing is substantially aligned to a network access node downlink cell timing, where a timing of the second transmission is configured semi-statically (402).

A method as in any above, implemented as (e.g., performed by) a computer program. A method as in any above, implemented as a computer program stored (e.g., tangibly embodied) on a computer-readable medium (e.g., a program storage device, a memory). A computer program comprising computer program instructions that, when loaded in a processor, perform operations according to one or more (e.g., any one) of the above-described methods. A method as in any above, implemented as a program of instructions tangibly embodied on a program storage device, execution of the program of instructions by a machine (e.g., a processor or a data processor) resulting in operations comprising the steps of the method. A method as in any above, further comprising one or more aspects of the exemplary embodiments of the invention as described elsewhere herein, and, in particular, one or more aspects of the exemplary embodiments of the invention as relating to exemplary methods described herein.

(8) In another exemplary embodiment, a program storage device readable by a machine, tangibly embodying a program of instructions executable by the machine for performing operations, said operations comprising: sending a first transmission comprising first downlink control information to a mobile node located within a first cell that is serviced by the machine (401); and sending a second transmission comprising second downlink control information to a relay node over a wireless communication link that comprises a backhaul link, where the relay node services a second cell that is different from the first cell, where a downlink relay node cell timing is substantially aligned to a network access node downlink cell timing, where a timing of the second transmission is configured semi-statically (402).

A program storage device as in any above, wherein the program storage device comprises a computer-readable medium, a computer-readable memory, a memory, a memory card, a removable memory, a storage device, a storage component and/or a storage circuit. A program storage device as in any above, further comprising one or more aspects of the exemplary embodiments of the invention as described elsewhere herein, and, in particular, one or more aspects of the exemplary embodiments of the invention as relating to exemplary methods described herein.

(9) In another exemplary embodiment, an apparatus comprising: at least one processor; and at least one memory including computer program code, the at least one memory and the computer program code being configured to, with the at least one processor, cause the apparatus at least to perform: sending a first transmission comprising first downlink control information to a mobile node located within a first cell that is serviced by the apparatus; and sending a second transmission comprising second downlink control information to a relay node over a wireless communication link that comprises a backhaul link, where the relay node services a second cell that is different from the first cell, where a downlink relay node cell timing is substantially aligned to a network access node downlink cell timing, where a timing of the second transmission is configured semi-statically.

An apparatus as in any above, further comprising one or more aspects of the exemplary embodiments of the invention as described elsewhere herein, and, in particular, one or more aspects of the exemplary embodiments of the invention as relating to exemplary apparatus described herein.

(10) In another exemplary embodiment, an apparatus comprising: first means for sending a first transmission comprising first downlink control information to a mobile node located within a first cell that is serviced by the apparatus; and second means for sending a second transmission comprising second downlink control information to a relay node over a wireless communication link that comprises a backhaul link, where the relay node services a second cell that is different from the first cell, where a downlink relay node cell timing is substantially aligned to a network access node downlink cell timing, where a timing of the second transmission is configured semi-statically.

An apparatus as above, where the first means for sending and the second means for sending comprise at least one transmitter or at least one transceiver. An apparatus as in any above, further comprising one or more aspects of the exemplary embodiments of the invention as described elsewhere herein, and, in particular, one or more aspects of the exemplary embodiments of the invention as relating to exemplary apparatus described herein.

(11) In another exemplary embodiment, an apparatus comprising: first transmission circuitry configured to send a first transmission comprising first downlink control information to a mobile node located within a first cell that is serviced by the apparatus; and second transmission circuitry configured to send a second transmission comprising second downlink control information to a relay node over a wireless communication link that comprises a backhaul link, where the relay node services a second cell that is different from the first cell, where a downlink relay node cell timing is substantially aligned to a network access node downlink cell timing, where a timing of the second transmission is configured semi-statically.

An apparatus as in any above, embodied within at least one integrated circuit device. An apparatus as in any above, further comprising one or more aspects of the exemplary embodiments of the invention as described elsewhere herein, and, in particular, one or more aspects of the exemplary embodiments of the invention as relating to exemplary apparatus described herein.

(12) In another exemplary embodiment, an apparatus comprising: a first transmitter configured to send a first transmission comprising first downlink control information to a mobile node located within a first cell that is serviced by the apparatus; and a second transmitter configured to send a second transmission comprising second downlink control information to a relay node over a wireless communication link that comprises a backhaul link, where the relay node services a second cell that is different from the first cell, where a downlink relay node cell timing is substantially aligned to a network access node downlink cell timing, where a timing of the second transmission is configured semi-statically.

An apparatus as in any above, where the apparatus comprises a network access node, a base station, a Node B, an evolved Node B, a donor base station, a donor Node B or a donor evolved Node B. An apparatus as in any above, further comprising at least one processor (e.g., coupled to the first transmitter and the second transmitter). An apparatus as in any above, where the at least one processor is configured to compose at least one of the first transmission and the second transmission. An apparatus as in any above, further comprising one or more aspects of the exemplary embodiments of the invention as described elsewhere herein, and, in particular, one or more aspects of the exemplary embodiments of the invention as relating to exemplary apparatus described herein.

(13) In another exemplary embodiment, a system comprising: the apparatus of any one of (3), (4), (5) or (6) and the apparatus of any one of (9), (10), (11) or (12) (e.g., respectively).

A system as in any above, further comprising one or more aspects of the exemplary embodiments of the invention as described elsewhere herein, and, in particular, one or more aspects of the exemplary embodiments of the invention as relating to exemplary apparatus described herein.

(14) In further exemplary embodiments, a method (e.g., for operating a RN), a program storage device (e.g., readable by a machine, tangibly embodying a program of instructions executable by the machine for performing operations) and an apparatus (e.g., a RN) comprising: receiving only one-third of a control signal transmission/payload; and reconstructing the control signal transmission based on the received one-third (i.e., the partial reception). In some exemplary embodiments, the received one-third comprises a third symbol out of three symbols (e.g., consecutive symbols).

The apparatus may comprise at least one processor; and at least one memory including computer program code, the at least one memory and the computer program code being configured to, with the at least one processor, cause the apparatus at least to perform the above-noted operations and/or other operations described herein. The apparatus may comprise one or more means for performing the above-noted operations. As non-limiting examples, such means may comprise at least one receiver and/or at least one processor. The apparatus may comprise one or more components or circuitries configured to perform the above-noted operations, including, as non-limiting examples: reception circuitry, processing circuitry, at least one receiver and/or at least one processor.

The exemplary RN may receive a subset of a control channel (e.g., one-third, as described herein) and reconstruct the contents based on that subset. The RN may be able to reconstruct the payload/transmission because the DeNB has sent the transmission/payload (e.g., PDCCH) with sufficient redundancy.

In other exemplary embodiments, the RN may receive a delayed copy of an otherwise normal PDCCH.

In further exemplary embodiments, the RN may transmit its PDCCH to the R-UEs during the first symbol.

The method, program storage devices and/or apparatus as described above, further comprising one or more aspects of the exemplary embodiments of the invention as described in further detail herein.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

The exemplary embodiments of the invention, as discussed above and as particularly described with respect to exemplary methods, may be implemented in conjunction with a program storage device (e.g., a computer-readable medium, a memory) readable by a machine (e.g., a computer, a mobile station, a mobile device, a mobile node), tangibly embodying a program of instructions (e.g., a program, a computer program) executable by the machine (e.g., by a processor, by a processor of the machine) for performing operations. The operations comprise steps of utilizing the exemplary embodiments or steps of the method.

The various blocks shown in FIGS. 20 and 21 may be viewed as method steps, as operations that result from operation of computer program code and/or as one or more coupled components (e.g., function blocks, circuits, integrated circuits, logic circuit elements) constructed to carry out the associated function(s). The blocks may also be considered to correspond to one or more functions and/or operations that are performed by one or more components, apparatus, processors, computer programs, circuits, integrated circuits, application-specific integrated circuits (ASICs), chips and/or function blocks. Any and/or all of the above may be implemented in any practicable arrangement or solution that enables operation in accordance with the exemplary embodiments of the invention.

Furthermore, the arrangement of the blocks shown in FIGS. 20 and 21 should be considered merely exemplary and non-limiting. It should be appreciated that the blocks may correspond to one or more functions and/or operations that may be performed in any order (e.g., any practicable, suitable and/or feasible order) and/or concurrently (e.g., as practicable, suitable and/or feasible) so as to implement one or more of the exemplary embodiments of the invention. In addition, one or more additional steps, functions and/or operations may be utilized in conjunction with those illustrated in FIGS. 20 and 21 so as to implement one or more further exemplary embodiments of the invention, such as those described in further detail herein.

That is, the non-limiting, exemplary embodiments of the invention shown in FIGS. 20 and 21 may be implemented, practiced or utilized in conjunction with one or more further aspects in any combination (e.g., any combination that is practicable, suitable and/or feasible) and are not limited only to the blocks, steps, functions and/or operations illustrated in FIGS. 20 and 21.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of an E-UTRAN (UTRAN-LTE) system, it should be appreciated that the exemplary embodiments of this invention are not limited for use with only this one particular type of wireless communication system, and that they may be used to advantage in other wireless communication systems, and, in particular, those wireless communication systems that provide for a similar relay arrangement (e.g., a relay node operating over a backhaul link via a donor base station), for example.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical region (both visible and invisible), as several non-limiting and non-exhaustive examples.

As known by one of ordinary skill in the art, a symbol is a measure or unit of time that is often employed within cellular communication systems. As a non-limiting example, the symbols referred to herein may correspond to OFDM symbols (OSs). In other exemplary embodiments of the invention, other measures or units may be utilized (e.g., different time durations, periods or blocks). Similarly, while shown herein with reference to 14 symbols (OFDM symbols) per frame, the exemplary embodiments of the invention are not limited to use therewith, and may be utilized in conjunction with different sizes of frames (e.g., having a greater or lesser number of symbols per frame).

Further, the various names used for the described parameters (e.g., GP, TA, etc.) are not intended to be limiting in any respect, as these parameters may be identified by any suitable names. Further, the formulas and expressions that use these various parameters may differ from those expressly disclosed herein. Further, the various names assigned to different channels (e.g., PDCCH, etc.) are not intended to be limiting in any respect, as these various channels may be identified by any suitable names.

As such, it should be appreciated that at least some aspects of the exemplary embodiments of the inventions may be practiced in various components such as integrated circuit chips and modules. It should thus be appreciated that the exemplary embodiments of this invention may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this invention. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method, comprising:
sending, within at least one of a first symbol time and a second symbol time, a first transmission comprising first downlink control information from a network access node to a first mobile node located within a first cell that is serviced by the network access node; and
sending, within at least a third symbol time, a second transmission comprising second downlink control information from the network access node to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell,

2. The method of claim 1, where the first, second and third symbol times occur consecutively.

3. The method of claim 1, where the second transmission is sent within the first, second and third symbol times.

4. The method of claim 3, where portions of the second transmission that are sent within the first and second symbol times comprise dummy information.

5. The method of claim 3, where power is shifted among different transmissions sent during the first symbol time such that a power of the portion of the second transmission that is sent within the first symbol time is reduced and a power of at least one other transmission sent within the first symbol time is increased.

6. The method of claim 3, where power is shifted among different transmissions sent during the second symbol time such that a power of the portion of the second transmission that is sent within the second symbol time is reduced and a power of at least one other transmission sent within the second symbol time is increased.

7. The method of claim 3, where power is shifted among different transmissions sent during the third symbol time such that a power of the portion of the second transmission that is sent within the third symbol time is increased and a power of at least one other transmission sent within the third symbol time is decreased.

8. The method of claim 1, where the first, second and third symbol times comprise control symbols, where the control symbols are embodied within a frame that further comprises data symbols, the method further comprising: sending a fourth transmission comprising backhaul data from the network access node to the relay node, where the fourth transmission is sent using a portion of the data symbols.

9. The method of claim 1, where the first, second and third symbol times comprise orthogonal frequency division multiplexing symbols.

10. The method of claim 1, where a downlink relay node cell timing is substantially aligned to a network access node downlink cell timing.

11. The method of claim 1, where a timing of the second transmission is configured semi-statically.

12. A program storage device readable by a machine, tangibly embodying a program of instructions executable by the machine for performing operations, said operations comprising: sending, within at least one of a first symbol time and a second symbol time, a first transmission comprising first downlink control information to a first mobile node located within a first cell that is serviced by the machine; and sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

13. The program storage device of claim 12, where the second transmission is sent within the first, second and third symbol times.

14. The program storage device of claim 13, where portions of the second transmission that are sent within the first and second symbol times comprise dummy information.

15. The program storage device of claim 13, where power is shifted among different transmissions sent during the first symbol time such that a power of the portion of the second transmission that is sent within the first symbol time is reduced and a power of at least one other transmission sent within the first symbol time is increased.

16. The program storage device of claim 13, where power is shifted among different transmissions sent during the third symbol time such that a power of the portion of the second transmission that is sent within the third symbol time is increased and a power of at least one other transmission sent within the third symbol time is decreased.

17. The program storage device of claim 13, where a downlink relay node cell timing is substantially aligned to a network access node downlink cell timing.

18. The program storage device of claim 13, where a timing of the second transmission is configured semi-statically.

19. The program storage device of claim 13, where the machine comprises a network access node, a base station, a Node B or an evolved Node B.

20. An apparatus comprising: first means for sending, within at least one of a first symbol time and a second symbol time, a first transmission comprising first downlink control information to a first mobile node located within a first cell that is serviced by the apparatus; and second means for sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

21. The apparatus of claim 20, where the second transmission is sent within the first, second and third symbol times.

22. The apparatus of claim 21, where portions of the second transmission that are sent within the first and second symbol times comprise dummy information.

23. The apparatus of claim 21, where power is shifted among different transmissions sent during the first symbol time such that a power of the portion of the second transmission that is sent within the first symbol time is reduced and a power of at least one other transmission sent within the first symbol time is increased.

24. The apparatus of claim 21, where power is shifted among different transmissions sent during the third symbol time such that a power of the portion of the second transmission that is sent within the third symbol time is increased and a power of at least one other transmission sent within the third symbol time is decreased.

25. The apparatus of claim 21, where a downlink relay node cell timing is substantially aligned to a network access node downlink cell timing.

26. The apparatus of claim 21, where a timing of the second transmission is configured semi-statically.

27. The apparatus of claim 21, where the apparatus comprises a network access node, a base station, a Node B or an evolved Node B.

28. An apparatus comprising: at least one processor; and at least one memory including computer program code, the at least one memory and the computer program code being configured to, with the at least one processor, cause the apparatus at least to perform: sending, within at least one of a first symbol time and a second symbol time, a first transmission comprising first downlink control information to a first mobile node located within a first cell that is serviced by the apparatus; and sending, within at least a third symbol time, a second transmission comprising second downlink control information to a relay node over a wireless communication link that comprises a backhaul link, where the second transmission is configured to enable the relay node to send, within the first symbol time, a third transmission comprising third downlink control information from the relay node to a second mobile node located within a second cell that is serviced by the relay node, where the second cell is different from the first cell.

29. The apparatus of claim 28, where the second transmission is sent within the first, second and third symbol times.

30. The apparatus of claim 29, where portions of the second transmission that are sent within the first and second symbol times comprise dummy information.

31. The apparatus of claim 29, where power is shifted among different transmissions sent during the first symbol time such that a power of the portion of the second transmission that is sent within the first symbol time is reduced and a power of at least one other transmission sent within the first symbol time is increased.

32. The apparatus of claim 20, where power is shifted among different transmissions sent during the third symbol time such that a power of the portion of the second transmission that is sent within the third symbol time is increased and a power of at least one other transmission sent within the third symbol time is decreased.

33. The apparatus of claim 29, where a downlink relay node cell timing is substantially aligned to a network access node downlink cell timing.

34. The apparatus of claim 29, where a timing of the second transmission is configured semi-statically.

35. The apparatus of claim 29, where the machine comprises a network access node, a base station, a Node B or an evolved Node B.
